(19) United States
(12) Patent Application Publication
(10) Pub. No.: US 2015/0046251 A1
(43) Pub. Date: Feb. 12, 2015

(54) METHODS AND SYSTEMS FOR ANALYZING KEY PERFORMANCE METRICS

(71) Applicant: Monica C. Smith, Parsippany, NJ (US)

(72) Inventor: Monica C. Smith, Parsippany, NJ (US)

(21) Appl. No.: 14/455,826

(22) Filed: Aug. 8, 2014

Related U.S. Application Data
(60) Provisional application No. 61/863,717, filed on Aug. 8, 2013.

(51) Int. Cl. G06Q 30/02; G06F 17/30

(52) U.S. Cl. CPC G06Q 30/0242; G06F 17/3002; G06Q 30/0201
USPC 705/14.41

(57) ABSTRACT

A method, computer system and non-transitory computer readable storage medium for updating attributes data of a plurality of media events; indexing a plurality of key performance indicators for a plurality of group keys using the attributes data; generating at least one predictive score associated with each group key based on the indexed data from a report table in the database that includes the indexed data and based on a plurality of predetermined rules; automatically adjusting the applied predictive score in real-time from the previously indexed all combinations based on the updated user input in the configuration module; applying the at least one predictive scores associated with the group keys to a plurality of thresholds; and providing the at least one media transaction recommendation for the group keys based on the applied threshold values and based on the automatically adjusting.

### CROSS REFERENCE TO RELATED APPLICATIONS

This application claims priority to U.S. Provisional Patent Application No. 61/863,717, filed Aug. 8, 2013, which is hereby incorporated herein by reference in its entirety.

### TECHNICAL FIELD

The present invention relates to methods, systems and computer-readable media for use in analyzing key performance metrics in the recommending of media buying decisions.

### BACKGROUND

In direct to consumer advertising and/or branded advertising, hundreds and thousands of decisions need to be made in a short period of time regarding media purchases, both buying and selling or canceling media that will have great impact on the success of the given campaign as well as possible return on investment (ROI). Previously, these decisions have been made using a variety of methods and systems that have a wide range in levels of automation, dependability, intelligence and accuracy. On the one hand, there exist cumbersome spreadsheets where each row needs to be evaluated in terms of a decision based on limited historical data and/or limited capacity of the buyer to handle the mass of data available. Media systems that buyers use are transaction driven and list the buys by date and time on a particular media source or station—they operate more like a purchase order system with limited analytics capabilities all being initiated by a particular media buy. Without a media buy, the system is very limited on how it can handle or ingest non-media data. On the other hand, a fully automated system has no room for user intervention in the decision making process.

Current solutions have not adequately solved the problems of evaluating cumbersome spreadsheets or integrating user intervention in the decision-making process. This is due to a variety of limitations including but not limited to: lack of defined and applied structure of Business Rules, Normalization of Metrics, limitations to easily view Media across both Media Sources, Stations, and across Campaigns, Creatives and Offers. Another limiting factor is the ability manage large quantities of Data across Media & Marketing channels for ingest, validation, and relational sourcing & attribution.

Media systems have further limitations on the data that they can ingest/validate and are more singularly focused to Telemarketing & Call Center Data and have limited or no capabilities to ingest Web, Mobile, Retail and other data types and/or the ability to attribute these sets of data to the media purchases (both historically and planned in the future). Further, other media systems focus on planning for a future upcoming media event with using 3rd party ratings, data samplings, demographic profiles, etc. from services like Rentrack, Arbitron Nielsen, etc. for Radio, Web and Short Form Spots prior to execution of the Media Buys but do are not efficient or effective measuring and analyzing results being generated so that the Agency & Marketer are able to quickly react and reshape the media schedules. The other systems are also very focused on Shorform Media Buys (SF), which are generally commercial spot lengths of 120 seconds or less, and have very limited capabilities in other types of media like Long Form TV & Radio, Web, Print, etc.

What is needed are methods, systems and computer-readable media for analyzing key performance indicators to generate improved recommendations for media buying decisions.

### SUMMARY

In one aspect of the present invention, a computer-implemented method for generating at least one media transaction recommendation for use in advertising a product or service, includes updating, at an approximately continuous rate, attributes data of a plurality of media events into a staging table in a database on a data storage device; at predetermined time intervals, indexing, using at least one processor, a plurality of key performance indicators for a plurality of group keys using the attributes data, each group key comprising at least four variables associated with a media event, the indexing of each key performance indicator being performed based on a ratio between actual value data that fits within the group key variables and target metric data for the key performance indicator, the indexing including all possible combinations of actual value data parameters representing at least one of a number of distinct and successive media events and a number of time periods of the media events, the indexing including all possible combinations of normalized (i) weightages assigned to each indexed key performance indicator, (ii) weightages assigned to combinations of indexed key performance indicators, (iii) weightages assigned to time periods of the actual value data, and (iv) weightages assigned to media events associated with the group keys, the weightages and time periods including default predetermined values; generating at least one predictive score associated with each group key based on the indexed data from a report table in the database that includes the indexed data and based on a plurality of predetermined rules, each predictive score being configurable through a configuration module where settings such as the weightages and time periods are configurable by user input; automatically adjusting the applied predictive score in real-time from the previously indexed all combinations, using at least one processor, based on the updated user input in the configuration module; applying the at least one predictive scores associated with the group keys to a plurality of thresholds, each threshold having default values for group keys that score within predetermined ranges and allowing for incorporating user input that overrides the default values; and providing the at least one media transaction recommendation for the group keys based on the applied threshold values and based on the automatically adjusting.

In another aspect of the invention, a computer system for generating at least one media transaction recommendation for use in advertising a product or service includes: a memory storing computer-executable instructions; and at least one data processor that when executed cause the computer system to perform steps of updating, at an approximately continuous rate, attributes data of a plurality of media events into a staging table in a database on a data storage device; at predetermined time intervals, indexing a plurality of key performance indicators for a plurality of group keys using the attributes data, each group key comprising at least four variables associated with a media event, the indexing of each key performance indicator being performed based on a ratio between actual value data that fits within the group key variables and target metric data for the key performance indicator, the indexing including all possible combinations of actual value data parameters representing at least one of a number of distinct and successive media events and a number of time periods of the media events, the indexing including all possible combinations of normalized (i) weightages assigned to each indexed key performance indicator, (ii) weightages assigned to combinations of indexed key performance indicators, (iii) weightages assigned to time periods of the actual value data, and (iv) weightages assigned to media events associated with the group keys, the weightages and time periods including default predetermined values; generating at least one predictive score associated with each group key based on the indexed data from a report table in the database that includes the indexed data and based on a plurality of predetermined rules, each predictive score being configurable through a configuration module where settings such as the weightages and time periods are configurable by user input; automatically adjusting the applied predictive score in real-time from the previously indexed all combinations based on the updated user input in the configuration module; applying the at least one predictive scores associated with the group keys to a plurality of thresholds, each threshold having default values for group keys that score within predetermined ranges and allowing for incorporating user input that overrides the default values; and providing the at least one media transaction recommendation for the group keys based on the applied threshold values and based on the automatically adjusting.

In another aspect of the invention, a non-transitory computer readable storage medium configured to store computer-executable instructions for generating at least one media transaction, when executed by at least one processor, cause a computer to perform: updating, at an approximately continuous rate, attributes data of a plurality of media events into a staging table in a database on a data storage device; at predetermined time intervals, indexing a plurality of key performance indicators for a plurality of group keys using the attributes data, each group key comprising at least four variables associated with a media event, the indexing of each key performance indicator being performed based on a ratio between actual value data that fits within the group key variables and target metric data for the key performance indicator, the indexing including all possible combinations of actual value data parameters representing at least one of a number of distinct and successive media events and a number of time periods of the media events, the indexing including all possible combinations of normalized (i) weightages assigned to each indexed key performance indicator, (ii) weightages assigned to combinations of indexed key performance indicators, (iii) weightages assigned to time periods of the actual value data, and (iv) weightages assigned to media events associated with the group keys, the weightages and time periods including default predetermined values; generating at least one predictive score associated with each group key based on the indexed data from a report table in the database that includes the indexed data and based on a plurality of predetermined rules, each predictive score being configurable through a configuration module where settings such as the weightages and time periods are configurable by user input; automatically adjusting the applied predictive score in real-time from the previously indexed all combinations based on the updated user input in the configuration module; applying the at least one predictive scores associated with the group keys to a plurality of thresholds, each threshold having default values for group keys that score within predetermined ranges and allowing for incorporating user input that overrides the default values; and providing the at least one media transaction recommendation for the group keys based on the applied threshold values and based on the automatically adjusting.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

FIG. 1 shows flowchart steps of an embodiment of the present invention.

FIG. 2 shows a flowchart representation of a product group hierarchy, which is incorporated into an embodiment of the present invention, to utilize historical results and indexes to buy media.

FIG. 3 illustrates a flowchart of both Brand Attributed and Consumer Response Attributed/Sourced Data, according to an embodiment of the invention.

FIG. 4 represents a “Truth” table that shows how recommendations are derived across use cases based on rules that use the performance of Media events over N Week time periods where N Week is a configurable range, according to an embodiment of the present invention.

FIGS. 5A, 5B, 5C and 5D represent how recommendations are scored based on the performance of Media events over N Week time periods, according to an embodiment of the present invention.

FIG. 6 shows the Group Key and how the Subindexes self-adjust based on data available and per time period, according to an embodiment of the present invention.

FIGS. 7A and 7B show a configuration module that allows for configuring the indexed metrics, according to an embodiment of the present invention.

FIGS. 8A and 8B show an index calculator that adjusts index values based on key performance indicator weightages, according to one embodiment of the present invention.

FIG. 9 illustrates an index composition on a platform where previous instances plus short term and longer term week trends are illustrated, according to an embodiment of the present invention.

FIG. 10 illustrates a detail view of a platform of a long form with group keys comprises five columns and corresponding media recommendations on each row, according to an embodiment of the present invention.

FIG. 11 illustrates a detail view of a platform of a short form with group keys comprises six columns and corresponding media recommendations on each row, according to an embodiment of the present invention.

FIG. 12 illustrates a table where, even though short form media can be bought in rotations, each individual Airing (column “Air Details”) or Instance is Scored through a variety of Metrics and Index, according to an embodiment of the present invention.

FIG. 13 shows Future Media Instances can be Bought (BUY), Sold (SELL/Canceled), or Retitled whereby the Media Instance is switched from one Creative versus another, according to an embodiment of the present invention.

FIGS. 14A and 14B illustrates examples of Buy, Sell and Retitle Actions that can be sent to media agencies for processing, according to an embodiment of the present invention.

FIG. 15 shows a future B.E.S.T.® recommendation summary, according to an embodiment of the invention.

FIG. 16 shows a detailed view of a B.E.S.T.® recommendation summary, according to an embodiment of the invention.

FIG. 17 illustrates an example of a computer system that may be configured to practice an illustrative embodiment of the invention.

### DETAILED DESCRIPTION

Some embodiments of the current invention are discussed in detail below. In describing embodiments, specific terminology is employed for the sake of clarity. However, the invention is not intended to be limited to the specific terminology and examples selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

The term “computer” is intended to have a broad meaning that may be used in computing devices such as, e.g., but not limited to, standalone or client or server devices. The computer may be, e.g., (but not limited to) a personal computer (PC) system running an operating system such as, e.g., (but not limited to) MICROSOFT® WINDOWS® NT/98/2000/XP/Vista/Windows 7/8/8.1 etc. available from MICROSOFT® Corporation of Redmond, Wash., U.S.A. or an Apple computer executing MAC® OS from Apple® of Cupertino, Calif., U.S.A. Computer configurations running other operating systems such as Linux and ChromeOS are also contemplated within the scope of the invention. However, the invention is not limited to these platforms. Instead, the invention may be implemented on any appropriate computer system running any appropriate operating system. Further, the invention may be implemented on a cloud computing unit and mobile devices. In one embodiment, the invention may be a cloud-based SaaS platform and able to be accessed on computers, tablets, ipads, smartphones, etc.

In one illustrative embodiment, the present invention may be implemented on a computer system operating as discussed herein. The computer system may include, e.g., but is not limited to, a main memory, random access memory (RAM), and a secondary memory, etc. Main memory, random access memory (RAM), and a secondary memory, etc., may be a computer-readable medium that may be configured to store instructions configured to implement one or more embodiments and may comprise a random-access memory (RAM) that may include RAM devices, such as Dynamic RAM (DRAM) devices, flash memory devices, Static RAM (SRAM) devices, etc.

The secondary memory may include, for example, (but is not limited to) a hard disk drive and/or a removable storage drive, representing a floppy diskette drive, a magnetic tape drive, an optical disk drive, a compact disk drive CD-ROM, flash memory, cloud instance, etc. The removable storage drive may, e.g., but is not limited to, read from and/or write to a removable storage unit in a well-known manner. The removable storage unit, also called a program storage device or a computer program product, may represent, e.g., but is not limited to, a floppy disk, magnetic tape, optical disk, compact disk, etc. which may be read from and written to the removable storage drive. As will be appreciated, the removable storage unit may include a computer usable storage medium having stored therein computer software and/or data.

In alternative illustrative embodiments, the secondary memory may include other similar devices for allowing computer programs or other instructions to be loaded into the computer system. Such devices may include, for example, a removable storage unit and an interface. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM)) and associated socket, and other removable storage units and interfaces, which may allow software and data to be transferred from the removable storage unit to the computer system.

The computer may also include an input device including any mechanism or combination of mechanisms that may permit information to be input into the computer system from, e.g., a user. The input device may include logic configured to receive information for the computer system from, e.g. a user. Examples of the input device may include, e.g., but are not limited to include, a mouse, pen-based pointing device, or other pointing device such as a digitizer, a touch sensitive display device, and/or a keyboard or other data entry device (none of which are labeled). Other input devices may include, e.g., but are not limited to include, a biometric input device, a video source, an audio source, a microphone, a web cam, a video camera, and/or other camera. The input device may communicate with a processor either wired or wirelessly.

The computer may also include output devices which may include any mechanism or combination of mechanisms that may output information from a computer system. An output device may include logic configured to output information from the computer system. Embodiments of an output device may include, e.g., but are not limited to include, display, and display interface, including displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc. The computer may include input/output (I/O) devices such as, e.g., (but not limited to) communications interface, cable and communications path, etc. These devices may include, e.g., but are not limited to, a network interface card, and/or modems. The output device may communicate with processor either wired or wirelessly. A communications interface may allow software and data to be transferred between the computer system and external devices.

The term “data processor” is intended to have a broad meaning that includes, e.g., but is not limited to include, one or more central processing units that are connected to a communication infrastructure (e.g., but not limited to, a communications bus, cross-over bar, interconnect, or network, etc.). The term data processor may include any type of processor, microprocessor and/or processing logic that may interpret and execute instructions (e.g., for example, a field programmable gate array (FPGA)). The data processor may comprise a single device (e.g., for example, a single core) and/or a group of devices (e.g., multi-core). The data processor may include logic configured to execute computer-executable instructions configured to implement one or more embodiments. The instructions may reside in main memory or secondary memory. The data processor may also include multiple independent cores, such as a dual-core processor or a multi-core processor. The data processors may also include one or more graphics processing units (GPU) which may be in the form of a dedicated graphics card, an integrated graphics solution, and/or a hybrid graphics solution. Various illustrative software embodiments may be described in terms of this illustrative computer system. After reading this description, it will become apparent to a person skilled in the relevant art(s) how to implement the invention using other computer systems and/or architectures.

The term “data storage device” is intended to have a broad meaning that includes removable storage drive, a hard disk installed in hard disk drive, flash memories, removable discs, non-removable discs, Cloud storage such as Amazon, Apple, Dell, Google, etc., and other storage implementations. In addition, it should be noted that various electromagnetic radiation, such as wireless communication, electrical communication carried over an electrically conductive wire (e.g., but not limited to twisted pair, CATS, etc.) or an optical medium (e.g., but not limited to, optical fiber) and the like may be encoded to carry computer-executable instructions and/or computer data that embodiments of the invention on e.g., a communication network. These computer program products may provide software to the computer system. It should be noted that a computer-readable medium that comprises computer-executable instructions for execution in a processor may be configured to store various embodiments of the present invention.

An objective of embodiments of the current invention is directed to a process for recommending media transaction decisions based on direct and indirect consumer response driven media and performance-based metrics combining any combination of consumer responses (Calls, Orders, Visits, Tweets, SMS, etc. are direct consumer response), impressions, gross rating points, HUT levels, circulations, lists, (these are indirect consumer responses), and media to score results. One embodiment of the invention measures scores via group keys with strategically designed and adjustable variables/components and measures scores over time periods. In one embodiment, scores can be indexed so that a variety of targets and metrics can be utilized. Indexes allow for normalizing and relating any number of variables and metrics to each other depending on the level of granularity that is sought or targeted. This also allows us to create weightages to these calculations and processes. The process can be smart and self-adapting and can also be configurable by allowing for selecting the key metrics to be used and configuring how to weight them in combinations. In one embodiment, the consumer response driven media involves media promoting a consumer response action such as a phone number, a SMS or text message, a URL, a Tweet, a Like, etc. The process can recommend media buying decisions based on the analysis of key performance metrics and how they compare to set goals using the marketer's historical data and the detailed schedule of all future media buys that have been booked. A key performance metric can be a Key Performance Indicator (KPI), which is a ratio or metric used to score a particular Media Event or set of values associated with media events.

Embodiments of the present invention may recommend media buying decisions based on the analysis of key performance metrics of different types of media. For example, in addition to DRTV, Branded TV, Radio, Web, email Lists, Links, SMS, for example, can also be included as the media. The media events can thus be used on the analysis of key performance metrics and compared with set goals using historical data and the detailed schedule of all future media buys that have been booked. The analysis can identify total media opportunities that have successfully performed in the past and are not currently booked or are under-booked, and historical airings that have not performed historically that may be booked in the future.

The following terms are intended to have broad meanings and are defined for explanatory purposes, by way of example, without necessarily limiting the terms to only the terms provided in these definitions.

Group Key—this is a grouping of defined key variables into a unique code that is used for purposes of definition and comparison based on specific attributes. The Group Key can be built from at least n number of variables or the Group Key can be a single variable that is uniquely defined through an independent process. In the examples contained in this document, the Group Key is defined using at least 4 variables for TV Media (Creative|Source|Day|Time) and can be expanded to create greater granularity such as adding Media Unit Length and/or Offer. Group Keys can be changed and expanded or reduced depending again on the summarization or granularity that is required by the Licensee

Buy Evaluate Sell Test (B.E.S.T.®) Recommendation—A scoring system that represents the performance levels of media based off of historical data and the Composite Index. The Composite Index (or B.E.S.T.® Index) can be the final scoring of the B.E.S.T.® process that determines the B.E.S.T.® recommendation.

In the examples contained in this document, a B.E.S.T.® Recommendation of BUY represents media performing at or above goals established by Licensee; a B.E.S.T.® Recommendation of EVAL represents media performing at a level within a variance range of the goal established by Licensee; a B.E.S.T.® Recommendation of SELL represents media underperforming below goal and the variance range of goal; and a B.E.S.T.® Recommendation of TEST that represents media with no historical performance.

Media Event—Represents an event or activity that is viewed by a consumer for purposes promoting products, goods, and services, and/or obtaining contributions, votes, or information, etc. and are generally represented or referred to as (but not limited to) commercials, spots, infomercials, programs, advertisements, articles, SMS text messages, email links, display ads, web search, banners, mails, inserts, catalogs, brochures, performances, etc. Note: Media Events are generally bought or purchased but can also be no charge or per inquiry, per lead, per order, per vote, per search, per visit, per action, etc.

Response (or Direct Response)—Represents consumer response or action to a media event including but not limited to calls, leads, orders, SMS texts, visits, votes, pledges, emails, mail, etc.

Indirect Response—Represents indirect consumer response based on profiles resulting from polls, metering, and/or statistical samplings such as Nielsen Impressions, GRPs (Gross Rating Points), HUT Levels, Circulations, census data, etc.

Source—Represents the source, host or provider of the media event such as (including but not limited to) TV Stations, Radio Stations, Web Sites, Social Sites, Streaming, Satellite, On Demand, emails, mail, publications, inserts, circulars, etc.

Time Period—This a specific period of time such as a week, day, month or groupings such as 2 weeks, 4 weeks, 52 weeks, nWeeks, YoY (Year over Year), MoM (Month over Month), WoW, etc.

Media Exposure Unit (Group)—Length or Size of a Creative featured in a Media Event. Examples include (but not limited to) short exposures such as short form media lengths :30, :60, :90, :120, 3 minutes, 5 minutes, etc. Further, the media exposure units can be long form media lengths of 28:30, 58:30 minutes. Additionally, the media exposure units can be print or web-based area, such as Quarter Page, Half Page, Full Page, 240×400; Mobile leaderboard: 320×50; Banner: 468×60; Leaderboard: 728×90; Square: 250×250, etc. . . . .

Campaign—A Campaign is a set or grouping of Creatives targeting a particular marketing effort or event. Creatives within a Campaign can be single or omni-channel.

Creative—this is the promotion, commercial, published element, display, link or advertisement that the consumer sees and what generates the response or image (Brand). For TV it would be an Infomercial, having a Media Exposure Unit format of greater than 5 minutes in runtime length and for Short Form Spots, these would have Unit Exposure Unit format lengths of 10 seconds to 5 minutes in runtime length that could be interchangable as a singular Creative or they could be separate Creatives.

The B.E.S.T.® Scoring System is a rules based scoring process or engine that has a Licensee definable framework that uses indexing for enabling the establishment and execution of configurable business rules, variables, weightages, data types and key metrics to score Media based on historical performance, both directly and indirectly through “Product” Hierarchies”, Source/Station Profiles and across one or more consumer response data sets, including but not limited to Calls, Orders, Visits, Likes, Tweets, Impressions, Circulations, lists, Retail, etc., for the purposes of scoring past media and applying quantifiable decisions for recommending and transacting current and future media purchases/acquisitions. A Licensee can be a business entity that licensees the use of the system. An index can be individual scoring of a KPI vs its corresponding target goal to create normalization. In the examples contained in this document, the Index is scaled to 100 where 100 and above represents a performing index and below 100 represent an underperforming Index.

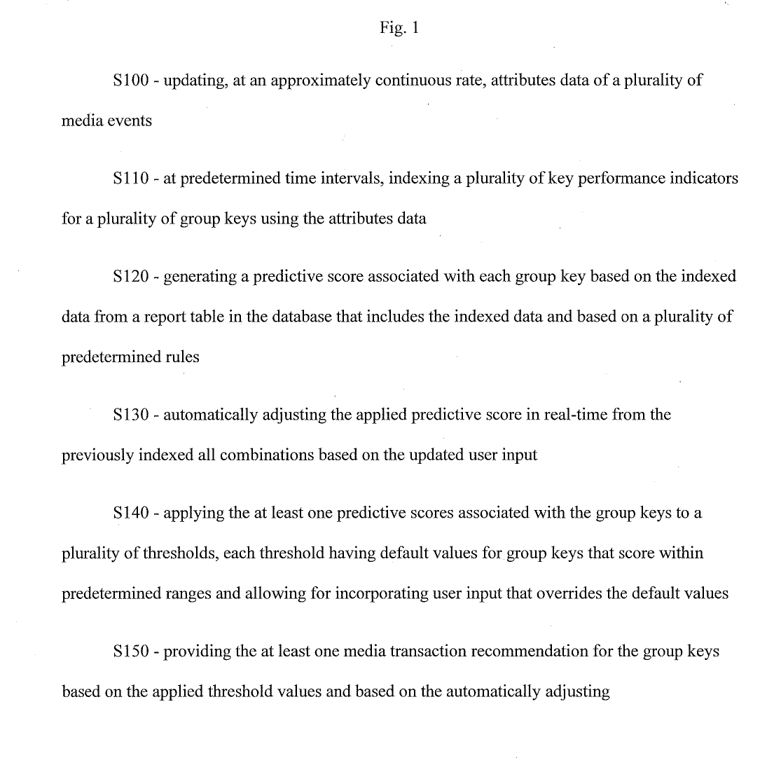

FIG. 1 illustrates a flow chart of a computer-implemented method for generating a plurality of media transaction recommendations according to one embodiment of the current invention. In step S100, the computer-implemented method can include updating, at an approximately continuous rate, attributes data of a plurality of media events into a staging table in a database on a data storage device. The attributes data can be imported into a database on the data storage device through a data ingest process, which can include importing records detailing individual media events such as airing, buys, emails, ads. The records can include the event source, the type of media event, the date of the media event, the time of the media event, the cost of the media event, the length or identifier of the media event, the frequency of the media event, the time period or range of the media event, the cost of the event, the Creative identifier, Offer details, the data provider, acquisition vendor or agency, the marketer, and the response mechanism. The records can include sourced or attributed records for each media event with calls, orders, leads, visits, sessions, tweets, likes, SMS texts, bids, votes, appointments, impressions, points, etc. The records can also include unsourced or unattributed records with calls, orders, leads, visits, sessions, tweets, likes, SMS texts, bids, votes, appointments, impressions, points, etc. Consumer responses that are unsourced and/or unattributed can then be sourced and/or attributed to the media events, as discussed above.

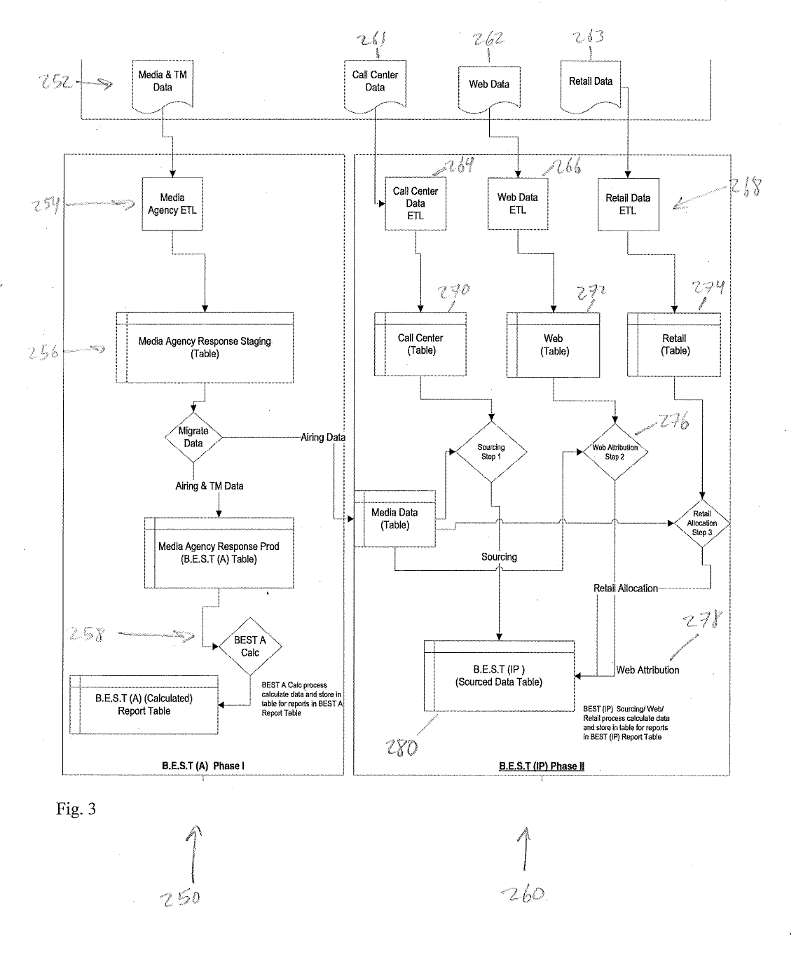

The data ingest process can occur at any level of frequency including, but not limited to, singular load, batch, EPI, real time, integrated, etc. via automated and/or manual processes or any combinations thereof. The data ingest process can be stored in a processing device, such as a computer, mobile device, and/or database system, warehouse, instance, etc. The data ingest process is illustrated in further detail in FIG. 3.

The attributes data can include any amount of historical, current and/or future data and be for any time frame hours, days, weeks, etc. In one embodiment, a minimum of n weeks of historical data plus all future Media Events is provided, where n can range from 1 to 520 weeks.

In step S110 of FIG. 1, the computer-implemented method can include at predetermined time intervals, indexing, using at least one processor, a plurality of key performance indicators for a plurality of group keys using the attributes data, each group key comprising at least four variables associated with a media event, the indexing of each key performance indicator being performed based on a ratio between actual value data that fits within the group key variables and target metric data for the key performance indicator, the indexing including all possible combinations of actual value data parameters representing at least one of a number of distinct and successive media events and a number of time periods of the media events, the indexing including all possible combinations of normalized (i) weightages assigned to each indexed key performance indicator, (ii) weightages assigned to combinations of indexed key performance indicators, (iii) weightages assigned to time periods of the actual value data, and (iv) weightages assigned to media events associated with the group keys, the weightages and time periods including default predetermined values.

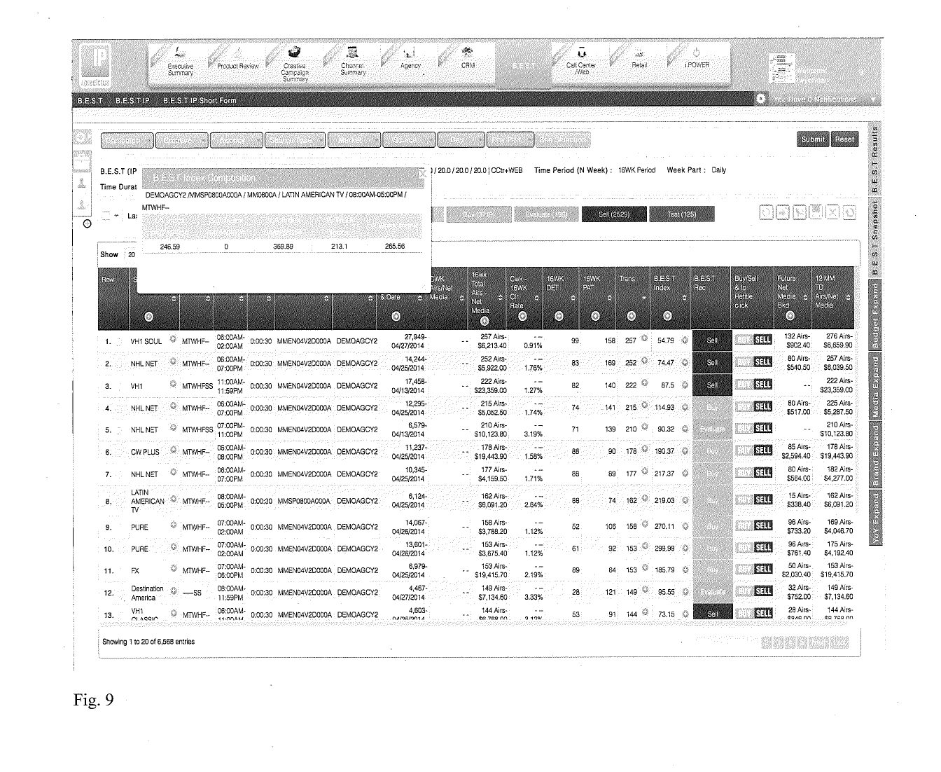

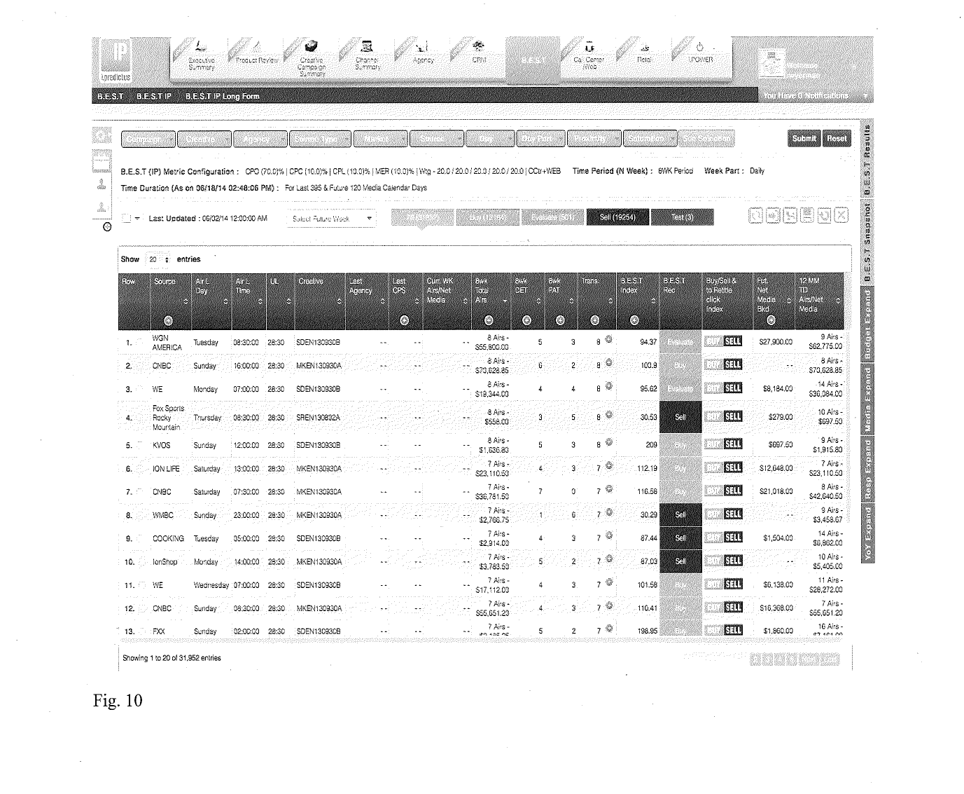

The Group Key can be expanded as needed for the type of Media and for the granularity of Media and Licensee Preferences. By way of example only, the Long Form Group can include five variables (See FIG. 10) and the Short Form Group Key can include six variables (See FIG. 9). Again these are configurable and can be changed or expanded as needed—a point of uniqueness is the utilization of a specifically defined group key along with utilization of the B.E.S.T.® Configuration Rules Framework. The media event can include either a single media event or a selected period of time. The group key is a grouping mechanism to organize data with particular characteristics so that they can be measured, evaluated, and trended over time. The Group Key can use a minimum of four variables and can be expanded to additional variables. The Group Key structure can include in one embodiment (i) a Media Event Source, where Media Event Source is represented as (including but not limited) a Station, URL, Link, Publisher, email, Location, etc.; (ii) a Time Unit, where the Time Unit is represented as Day, Rotation, Daypart, Hour, etc. as defined by the user in configuration settings a Time and a Creative; (iii) Time as it exists/occurs, and Creative which represents the Event that the consumer viewed including but not limited to a TV or Radio Commercial, Infomercial, Program, Spot, Show, email, mail, Advertisement, Article, Appearance, Appointment, or any other viewable medium. A purpose of the Group Key can be to create a unique string of variables that can be compared and trended over any time period.

In one embodiment, some granular elements of a media event are combined into the group key that can be tracked over time. In an embodiment for direct response broadcast media, the group key can be a combination of the following elements: 1) media source (such as the station or the network), 2) day of the week, 3) time of the broadcast and 4) Creative (or Campaign or Offer depending on Configuration Module selection). Since the date of the airing is variable, in one embodiment the date of the airing is not included in the group key and the system can be used for trending. Other sub-combinations for the group key are also contemplated, including the date of the airing.

The group key can be a unique identifier of a media event that normalizes data by combining elements of the source of the media event and elements of the time of the event where time is fragmented into its components and certain components are eliminated and others are selected to be included in the group key. For example, the time components that can be eliminated are the specific month, day of the month and year of the media event in order to allow for performance trending of the group key. The performance trending can allow for the evaluation and analysis of performance metrics for a group key over any period of time in terms of how recent the event is to the current date and length of time. The Week Range selections in the B.E.S.T.® Configuration Module are a key factor as well as whether the Data is grouped by Daily, Weekday/Sat/Sun or Weekday/Weekend (by way of example). For Print, Web and other Media types, these Time factors may include Weeks, Months, quarters and more or any variation thereof.

The media event can include, but is not limited to include, television time for the purpose of brand awareness, direct response television time to sell a product or service or generate a lead, radio time for the purpose of brand awareness, direct response radio time to sell a product or service or generate a lead, web advertising, SMS messaging and print advertising. The format of the media can include, but is not limited to include, a long form infomercial of 28:30 in length, short form commercial of various lengths under 28:30 including, but not limited to, 5 minutes, 120 seconds, 60 seconds, 30 seconds, 15 seconds, full page print advertisement, half page, quarter page, banner ad, search engine keyword(s), SMS text messages.

The group key for Direct Response Television using long form format (more commonly known as an infomercial that runs 28:30) equals the combination of media source/day of the week/air time of broadcast.

The group key for the short form format can equal the combination of media source/day rotation/air time rotation of broadcast where day rotation equals a range of days or specific days and time rotation is a range of hours in a day in which the commercial is scheduled to air.

The group key for direct response print advertising can be identified by the elements that compose a unique ad placement coded with a unique source code that refers to a minimum combination of criteria including but not limited to the publication (or code, abbreviation or other reference referring to the publication), date (or date code, or other Date and/or Time reference), and Product and/or Offer and/or creative (as described above in singularity or in combination). The Frequency, position and even ad type could be added variables to the key that may or may not be included.

While Group Key can have a minimum structure as defined above, it can also be subdivided to provide further refinements within the Group Key or across all Group Keys. As an example, the Group Key can include an Offer to further refine the Group Key or to create subdivisions. This can be done for AB Testing of Offers and promotions that can be Tied to or rolled up to the Creative or Campaign. The Offer can be defined as a package of products or services and incentives grouped in an advertisement to generate response.

As another example, the Group Key can include the term Agency to further refine the Group Key or to create subdivisions so Agency data and/or performance are better isolated.

As another example, the Group Key can include the terms Format, Length, Size, Shape, Color or other similar characteristics to further refine the Group Key or to create subdivisions.

The Group Key structure can vary between Marketing Channels but be unique within the Marketing Channel. For example, Short Form Television Media Events can use the same Group Key Structure, however, subdivisions can be used to further refine related events if required.

The media event may refer to a single instance of an advertisement that reaches a consumer via various channels that include, but not limited to, broadcast or print or web or SMS messaging. A media event can include a TV Special, an email blast and/or mailing, etc.

The target performance metrics and values can be user-defined goals for a specific advertising campaign featuring a specific product and offer referring to such common metrics in Direct Response Television (DRTV) and radio. Additionally, the Branded side of TV and Radio may also be included in the target performance metrics and values whereby there may not be a direct consumer response but may be singularly or in combination an indirect metric such as Impressions, cost per thousand impressions (CPM), GRP, Circulation, etc. In this way, a large targetable market can include the Fortune 500 Brands many of whom do not use DRTV. The common metrics that can be user-defined for a specific advertising campaign include, but are not limited to, [media] cost per order (CPO), media efficiency ratio (MER), phone conversion rate, clearance rate, cost per airing (spot), cost per call (contact, CPC), cost per thousand impressions (CPM) and return on investment percent (ROI) where, in this process, in the case of CPO, the index equals the CPO allowable (or target) for a specific product and offer divided by the individual airing's actual CPO times 100. The MER index equals the individual airing MER divided by the MER target for the specific product and offer.

The parameter weightings may be configurable by the user based on his/her preference to focus on events in the short term or long term trend in influencing the recommended action where, in this version of the B.E.S.T.® process, the user assigns a weight (in the form of a percentage) of not greater than 50% to at least 2 of the five parameters. Weights can be assigned to all 5 parameters but the total for all five must equal 100%.

Key performance indicators (KPI) of Step S110 of FIG. 1 are further explained. The Group Key can be evaluated by at least one performance metric or KPI. Also, all the Performance Metrics can be Indexed so that they are normalized and can be used in any combination or compared, which decreases total computing processing time and resources. In an aspect of the process, the following KPI's can be included in the resolving process:

Media Cost per Order (CPO)—where Media cost can be Gross or Net Media of the Event and an Order is defined as the consumer making a purchase or placing an Order for what is being offered through the Media Event including but not limited to Product(s), Services(s), Information, Reservation(s), Contribution(s), Ticket(s), Vote(s) or other transactions in exchange for immediate or deferred payment. This KPI can be used on a per Event basis or summarized over a selected period of time. For example: Sum(NetMedia)/Sum(Orders)=CPO.

Media Cost per Contact (CPC)—where Media cost can be Gross or Net Media of the Event and Contact is a Consumer Response action via a devise or entity. This KPI can be used on a per Event basis or summarized over a selected period of time. For example: Sum(NetMedia)/Sum(Calls)=CPC.

Media Cost per Lead (CPL)=where Media cost can be Gross or Net Media cost of the Event and Lead is a Consumer Response action via a devise or entity whereby the Consumer provides the requested information to be contacted in the future for any variety of purposes such as to sell goods and/or services, or to provide information, secure reservations, contributions, voting or other. This KPI can be used on a per Event basis or summarized over a selected period of time. For example: Sum(NetMedia)/Sum(Leads)=CPL.

Media Efficiency Ratio (MER)—where Media cost can be Gross or Net Media of the Event is compared versus revenue generated as a result of the Consumer Action including but not limited to the consumer's acquisition of Product(s), Services(s), Information, Reservation(s), Contribution(s), Ticket(s), Vote(s) or other transactions in exchange for immediate or deferred payment. This KPI can be used on a per Event basis or summarized over a selected period of time. For example: Sum(GrossRevenue)/Sum(NetMedia)=MER.

Return on Investment (ROI)—where all defined corresponding and allocated costs are measured against Revenue generated as a result of the Consumer Action including but not limited to the consumer's acquisition of Product(s), Services(s), Information, Reservation(s), Contribution(s), Ticket(s), Vote(s) or other transactions in exchange for immediate or deferred payment and then further measured against the Gross or Net Media cost of the Event. ROI can be done on either individual or Summation of Media Events. ROI can also be further defined on a per Order or per Event basis.

Media Cost per Thousand (Impressions or Circulations) (CPM)—Lead where Media cost can be Gross or Net Media cost of the Event and “per Thousand Impressions” are estimated or actual Consumer View actions via a devise or entity whereby the Consumer watches or reads content of the Media Event for any variety of purposes such as to sell goods and/or services, or to provide information, secure reservations, contributions, voting or other. This KPI can be used on a per Event basis or summarized over a selected period of time. For example: Sum(NetMedia)/Sum(Impressions/1000)=CPM. Note: Impressions or Circulations can be at an aggregate Household level or it can be at one or more demographic levels inclusive of ages and or gender.

In one embodiment, when the purpose of the media event is brand awareness, the target and historical performance metrics change from a revenue or order perspective to an audience reach and frequency perspective where the metrics include, but are not limited to, [media] cost per household rating point, [media] cost per demographic rating point, [media] cost per thousand (CPM), commercial clearance rate and frequency of airings. Further, other factors that can be incorporated into the scoring process can include Cost per Event/Spot variances, Rate Sensitivity, Proximity (time distance between media events on same Station or Source), and Saturation (number of media events in same Market, and/or across National Stations).

In Step S110 of FIG. 1, the computer-implemented method can includes indexing based on a ratio between actual value data that fits within the group key variables and target metric data for the key performance indicator. The actual value data can include parameters representing a number (N) of current or recent distinct and successive events and a number (N) of historical groupings of events.

The selection of actual value data can include historical media events data. The historical media data can include the parameters which consist of a pre-defined number (three, in this example) of the most recent airings going back a specific period of time (the past 395 days, by way of example in this process—time period may be more or less depending on the media data base size, the length of time that the Licensee wants to utilize and whether historical data is available or applicable for the Media Event(s) based on the Group Key or Retitling feasibility.) that match a group key and a pre-defined number (two, in this example) of distinct grouped time periods in which airings that match the group key may or may not have run: a predefined number of successive weeks (4, in this example) and n weeks where n is defined by the user.

For example, CPO Index can be calculated using a CPO Target (or Goal) vs. Actual CPO (as defined above) times one hundred. A CPC Index can be calculated using a CPC Target (or Goal) vs. Actual CPC (as defined above). CPL Index can be calculated by using a CPL Target (or Goal) vs. Actual CPL (as defined above). MER Index can be calculated using a MER Target (or Goal) vs. Actual MER (as defined above). ROI Index can be calculated by using a ROI Target (or Goal) vs. Actual ROI (as defined above). CPM Index can be calculated using a CPM Target (or Goal) vs. Actual CPM (as defined above). In one embodiment, the actual value data used in indexing the at least one key performance indicator can include the data that fits the parameters of the identified group key. By indexing actual historical values of a metric fitting within the framework of a group key against the target value, multiple metrics can be used to evaluate a media event. Otherwise, since the scale of each metric is often very different from each other, multiple metrics could not be used for the evaluation. An example of indexing is illustrated in FIG. 9. Other events besides than just LF DRTV are also possible including Rotations (Short Form and Brand Media) as well as Dayparts. In particular, a media event can be thought of as a single program slot but we need to also consider a Media event as a Rotation or Daypart with multiple media events combined and scored within the definition of the Rotation and/or Daypart.

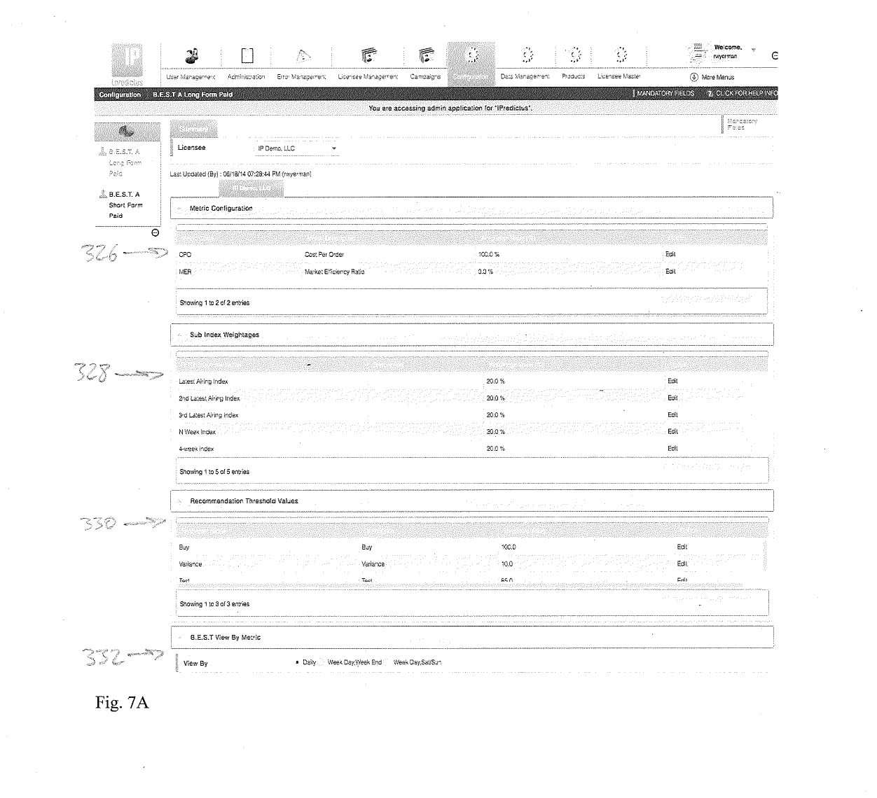

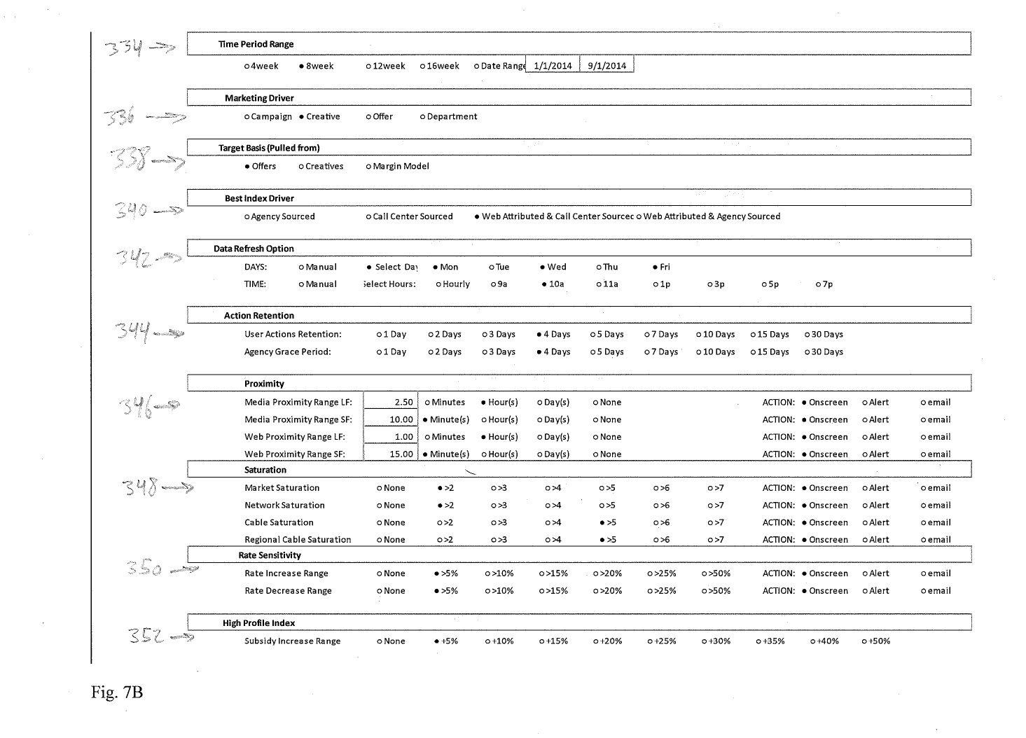

An evaluation of multiple indexes can use weighting each index as to its contribution to a predictive score. In FIG. 1, step S110 shows that the indexing can include normalizing all possible combinations of weightages assigned to each indexed KPI, combinations of indexed KPIs, time periods or airings. The calculated indexes can be normalized based on the Metrics vs their Target Values so that their corresponding Index can be compared and evaluated against other Indexes. The group key can be normalized with time values defined in the Configuration Module (FIG. 7). The Index Values for the Group Key are evaluated and scored based on the time periods of the actual value data provided that the time periods fall into the B.E.S.T.® Configuration SubIndex time values. The weightages and time periods can be user-selectable and can thus be defined by user input. Thus, the weightages and time periods can be defined by user input and the time periods of the actual value data can fit within the identified group key.

The indexing allows for the evaluation of comparisons of various goal or target performance metrics against actual result metrics so metrics of different scales and types are normalized and therefore can be compared and combined into a predictive score. Each of the metric indexes has the potential, in the case of using more than one metric, of being weighted by the user as to its contributory significance to the predictive score so the user can configure them to adjust the recommendations to meet the advertiser's business objectives.

The B.E.S.T.® process parameters are time-based media events within a group key where different values of N (number) of the most recent events are analyzed along with aggregate level trending variables such as N number of weeks or year to date weeks or year over year comparisons of different time frames where each event and/or trending variable has the potential of being weighted by the user as to its contributory significance to the predictive score.

The Key Metrics may be combined in one embodiment. The Indexing of Key Metrics and KPI's (as described above) enable the usage of one or more of these to be used in the scoring process. This is particularly useful when analyzing Media Events with different objectives such as by way of example: CPO and CPM, or CPC and ROI, or MER, ROI and CPM, etc.

Further, time periods and time groupings can be parts of the trending process and whose Time Groupings can be ranged over defined or user-selected date ranges. Again, these may be user-selectable and include but are not limited to the following: 1) nWeek—where n=Number of selectable weeks to trend and/or view; 2) nLA—where n=Number of selectable historical Airings to trend and/or view; 3) Rotation—Time Blocks structured within hour ranges across one or more days in a media week; 4) Dayparts—segmenting a day in blocks of time based on how media is bought and sold. Since media sources define their own day parts based on their programming schedules and audience, some overlapping may exist so the Dayparts may be based on a more normalized model; and 5) Weekparts—This is a grouping days within a week such as Weekdays (Monday-Friday), Weekend (Saturday and Sunday) or combinations thereof. In one embodiment, time periods can be used in conjunction with the Time Groupings to define the date range that is being considered and used.

Time Period refers to the B.E.S.T.® Configuration Module and how Data is organized and grouped such as Daily, Weekday/Sat/Sun or Weekday/Weekend. Depending on which criteria is used in the Configuration Module, the results and corresponding Indexes will be different. For example, Daily is much more granular and will have many more Group Key records vs Weekday/Weekend. The group key can be expanded to provide greater granularity by adding media unit length values.

The term media exposure unit can be used to define and organize the Group Key for analysis and comparison over the Time Period. The Time Grouping is generally aligned with how the Event within the Marketing Channel is acquired, purchased or actioned on. For example, in one embodiment, the media exposure unit can be a Long Form or Program Length Media in lengths of 58:30, 30:00, 28:30, 28:00, 27:30, 20:00, 15:00 minutes or similar durations. As another example, the media exposure unit can be a Short Form Length Media in lengths of :15, :20 , :30, :60, :90, :120 (2:00), :180 (3:00), :240 (4:00), :300 (5:00), or similar durations. Alternatively, the media exposure unit can describe other forms of advertisement such as print. For example, the media exposure units can be print or web-based area, such as Quarter Page, Half Page, Full Page, 240×400; Mobile leaderboard: 320×50; Banner: 468×60; Leaderboard: 728×90; Square: 250×250, etc. . . . .

Time Period(s) of Group Key. Again, this can vary among and between Marketing Channels and can be applied in combinations including but limited to: Daily, Weekly, Monthly, Quarterly, Annual, Day over Day, Week over Week, Month over Month, Quarter over Quarter, etc.

Multiple Time Periods for the Group Key can exist and enable comparisons of trends such as (by way of example): 2 weeks, 4 weeks, 8 weeks, 12 weeks, 16 weeks, 26 weeks, 52 weeks, etc. These are part of the Sub Index Variables and are selectable and weighted by Licensee per their Business Rules.

In Step S120 of FIG. 1, the computer-implemented method can include generating at least one predictive score associated with each group key based on the indexed data from a report table in the database that includes the indexed data and based on a plurality of predetermined rules, each predictive score being configurable through a configuration module where settings such as the weightages and time periods are configurable by user input. The Configuration Module can provide a mechanism to vary and adjust the predictive score to specifically driven business rules and objectives of the user. The Module includes but is not limited to the following and can be increased or reduced accordingly as needed or desired:

There are many components and variables that can be included but core functionality can be based on the following configuration. First, Group Key Driver Options may be included where a Level of Hierarchy may be selected to be used. Next, Sub Index Weightages may be used: Last event, 2nd Last Event, nLast Event, nWeeksRange1, nWeek2Range2, etc. Next, a Time Period may be used such as Daily, Weekday/Weekend, Weekday/Sa/Su, etc. Further, nWeeksRange1 may be used such as Selection of 4/8/12/16 weeks and nWeeksRange2, a Selection of 4/8/12/16 weeks. Next, a Metric Configuration can include CPO, CPC, CPL, MER, ROI, CPM, etc. and corresponding Weightages. Next, Target Values can include Offer Default or Margin Model Targets for CPO, MER, CPC, ROI, CPM, etc. Further, Refresh Cycle Options can include Days, Times; Long Form and Short Form. Next, Compliance can be used to include a Grace period (Agency Action), Retention period (Buy/Sell/Retitle (B/S/R) User Action, which is saved and pushed by User to the Media Agency. Next, a B.E.S.T.® Index Data Set can include Agency Sourced, IP Sourced, Web Attributed, etc. Next, B.E.S.T.® Configuration Options for enabling INDEX FACTOR SUBSIDIES to be used in B.E.S.T.® process as offsets to lower SELL Indexes and a higher EVAL range. Options would include Range Amounts, etc. Next, Country can be used (Default Refine Option to drive Views for USA or ALL); and Language (Default to English).

KPI Performance Metric or Metrics may be used and Weighted as described above. Although individual KPIs by themselves could be used, the B.E.S.T.® process is more universal and more expansive if the Index versions are used and this also enables them to be used in combination. The Weightage is used to balance or skew the results of a particular Index and Subindexes.

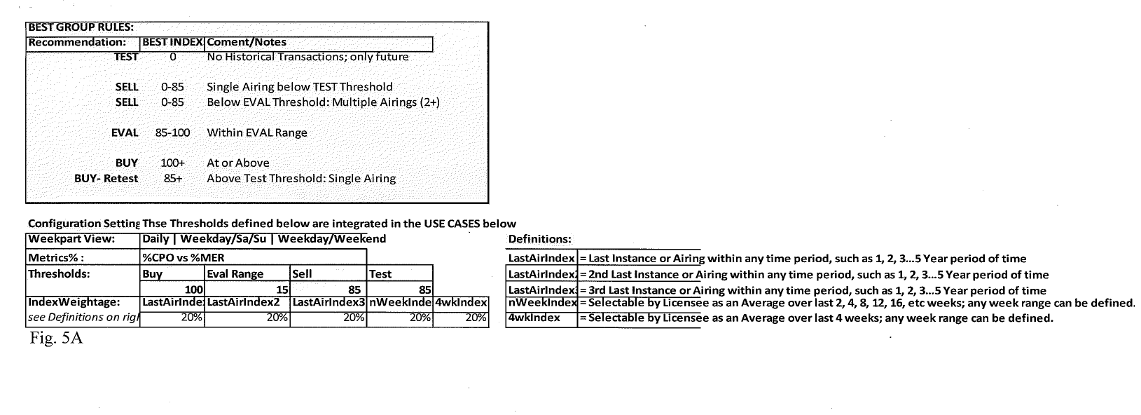

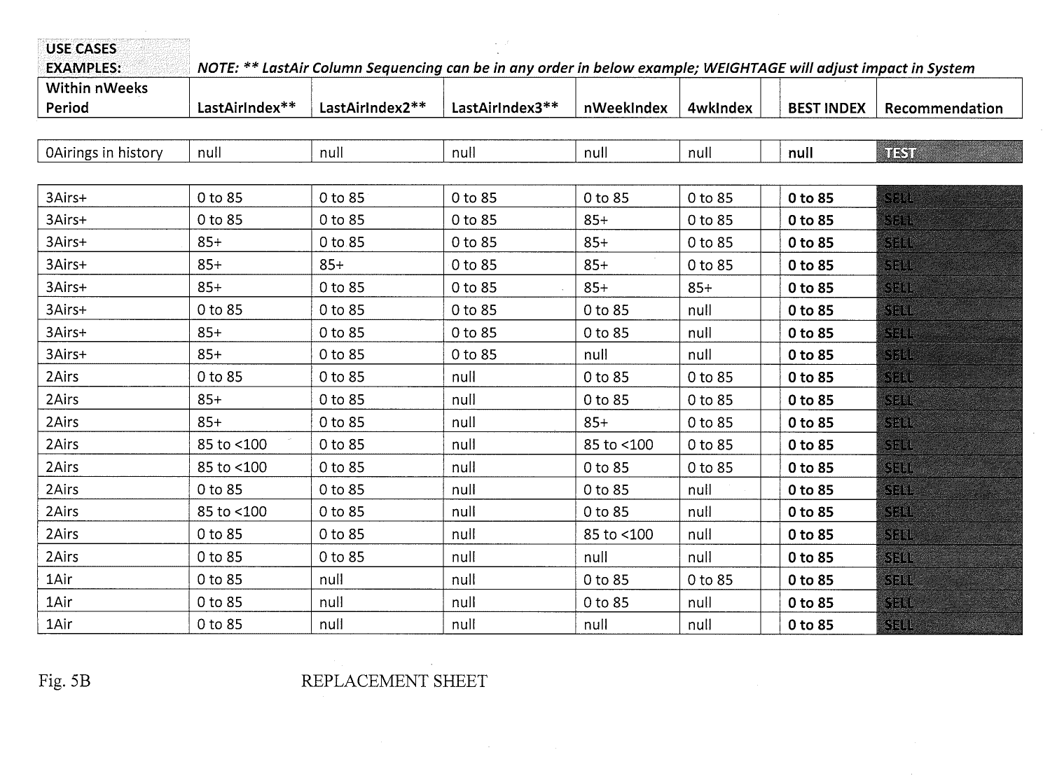

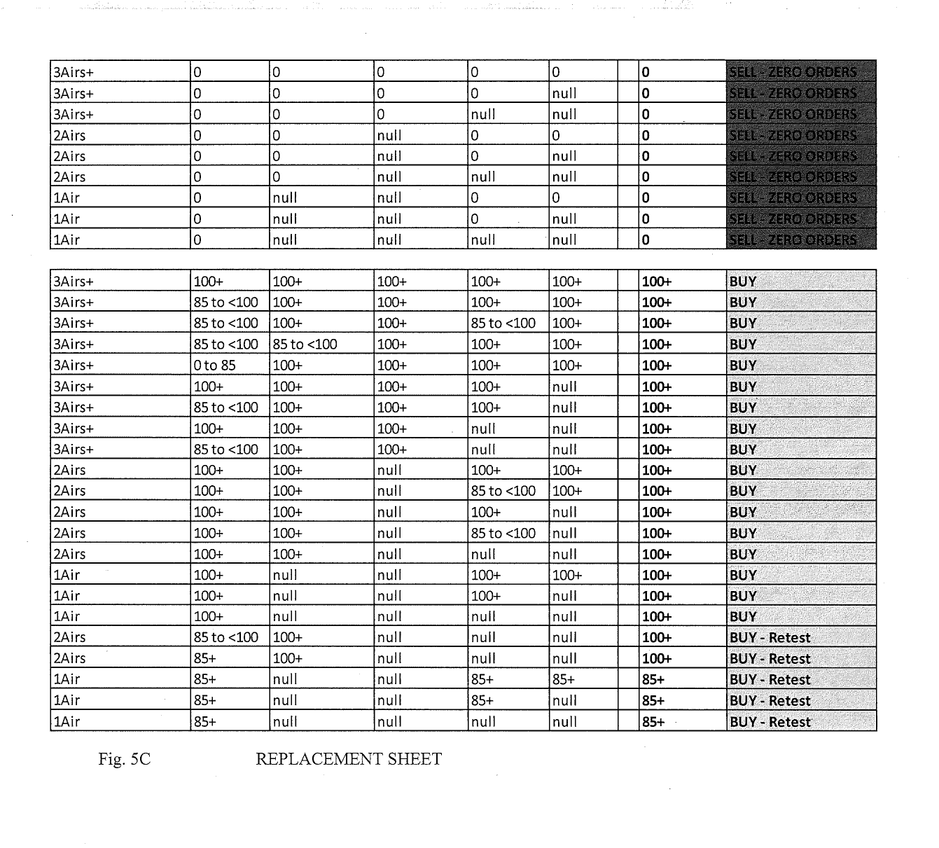

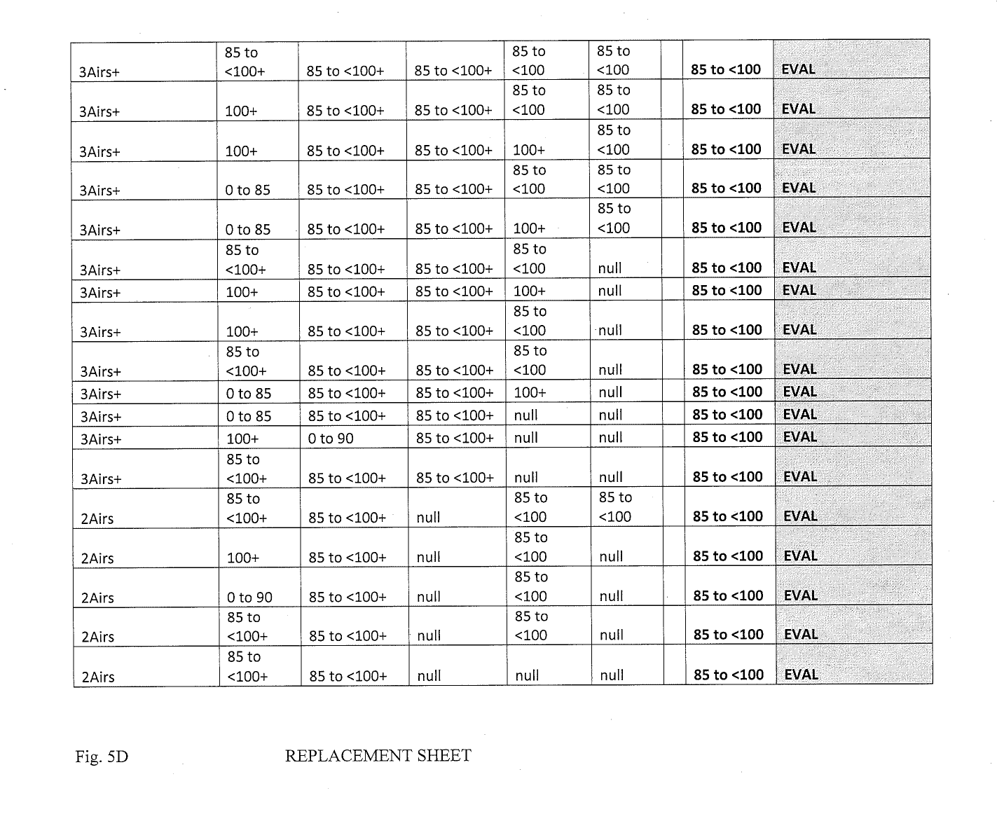

An embodiment of the current invention has a defined set of characteristics and variables and organizes these over different Time Groupings and Time Periods, computing their KPI's, Indexing the KPI's and then using a configuration module to create the structure for the B.E.S.T.® process. As part of the configuration module, the various thresholds for recommending media actions can be modified by the user. For example, by default, in one embodiment, if a score exceeds 100.00, a buy recommendation can be provided, if the score is between 90.00 and 100.00, an evaluate recommendation can be provided, and if the score is between 0.00 and 90.00, a sell recommendation can be provided. The Predictive score can then be subjected to two considerations: 1) A Variance Threshold; and 2) a Test Threshold. Examples can be seen in FIG. 5.

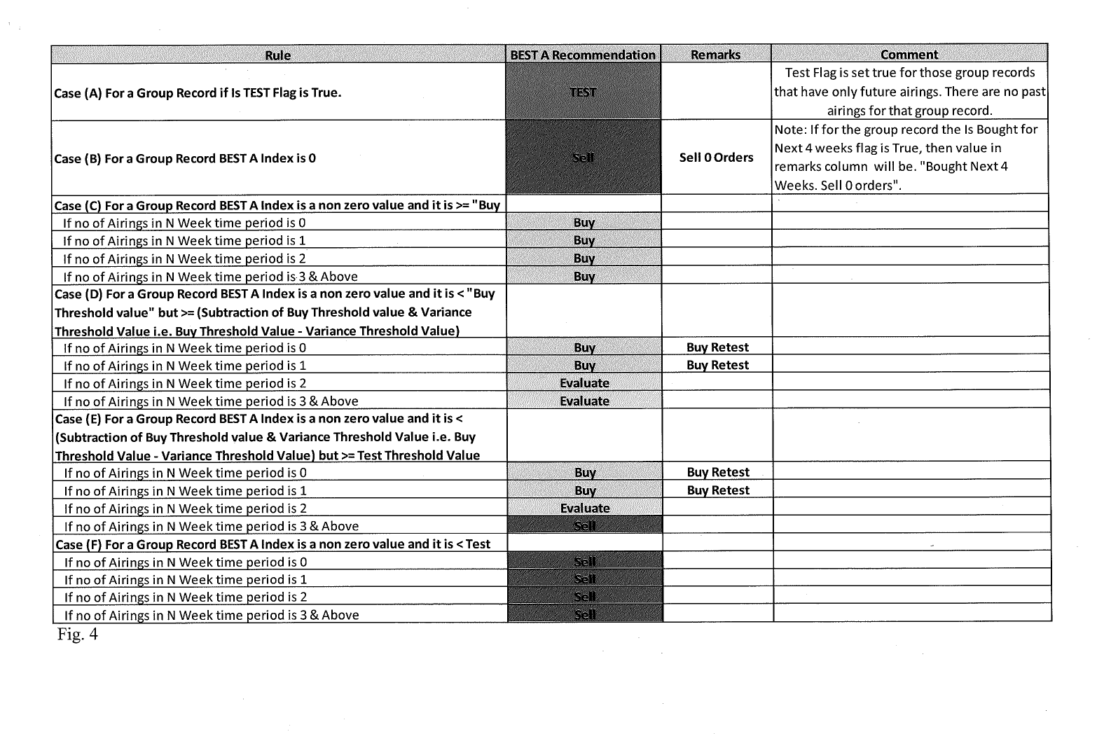

The Variance Threshold determines the range for the Score where the recommendation would be to “Evaluate” the specific airing, for example, for a specific group key. The user inputted Threshold must be between 1 and 15. For example, if the Threshold is −10%, then a Score of between 90 and 100 would result in an “Evaluate” recommendation for a non-Test airing. The Test Threshold determines the minimum score needed for an airing classified as a test airing before it can be recommended as a “Buy-Retest”. A test airing can be one that aired 0, 1, or 2 times in the past 395 days. For example, if the Test Threshold is 75, the score for the test airing needs to be 75 or above in order to get a “Buy-Retest” recommendation. The user inputted Test Threshold must be between 40 and 95 but should not overlap the Variance Threshold; in other words, if there is an overlap, it may be forced to be between 40 and (1 less Variance Threshold). For example, then, if the Variance Threshold is −10%, the Test Threshold will be forced to be between 40 and 90. Based on the generated score, a media recommendation is outputted to the user. The process may be implemented on hardware, software, or a combination thereof. Using the configuration module, a variance threshold that determines the range for a Score where an Evaluate recommendation would be outputted for a specific group key can be modified by the user. The variance threshold can be user-input and can be between 1 and 15. For example, if the threshold is −10%, then the Score of between 90 and 100 would result in an Evaluate recommendation for a non-Test group key, as seen in FIGS. 3 and 4.

The predictive score can represent 100% of a weighted average of one metric associated with the five parameters where each Index in the calculation is (in this example) either a CPO index or an MER index. Alternatively, the final Predictive Score can represent a weighted average between multiple indexes as, in this example, the CPO based score and the MER based score where the user determines the weight applied to each score.

Further as part of the configuration module, a test threshold that determines a minimum score needed for a group key can be classified as a test group key before it can be recommended as a “Buy-Retest.” For example, if the test threshold is 75, the score for the test airing can be 75 or above in order to get a “Buy-Retest” recommendation. In one embodiment, the test group key is one that aired 0, 1, or 2 times in the past 395 days.

In step S160 of FIG. 1, the computer-implemented method may include automatically adjusting the applied predictive score in real-time from the previously indexed all combinations, using at least one processor, based on the updated user input in the configuration module (Components). In addition to the above unique characteristics, the calculation process is self-adjusting or “Smart” whereby the B.E.S.T.® Index automatically re-calibrates the weightages assigned to each of the components based on which Component Indexes are calculated based on data availability for the Group Key. The following are examples of how the formula recalibrates and based on an even distribution of 20% for each of the 5 Components. See more examples in FIGS. 4-6.

If the Group Key has all 5 components populated and the Weightages in the configuration Module are set at 20%, then the corresponding Component Index is multiplied by the 20% value and the final score or value is the sum of all five of these. However, the user can adjust this component index to match the user's goals and the weightages can thus be changed at any time.

If the Group Key is missing a populated value/Index in one or more of the Component Indexes, then the Weightages are proportionately adjusted. For example, if one of these Components were missing, then the 20% distribution across five Component Indexes would automatically adjust to 25% across the four populated component Indexes. The same would occur if there were only three or two or one populated Component Index. In contrast to embodiments of the present invention, other systems in the art set missing component values to zero, which distort the results of the distribution. By proportionately adjusting the weightages based on missing values/indexes, a more accurate representation of the distribution can be provided. Further, by pre-calculating for this scenario, tens and hundreds of thousands of records can be seamlessly displayed automatically without undue distortion.

If the Component Indexes were weighted differently, then the weightages would be proportionately adjusted to maintain the proportionate Weightage differentials. If none of the Component Indexes are populated, which would be due to no historical data, then Null would be the final score or value and it would be flagged as “TEST”.

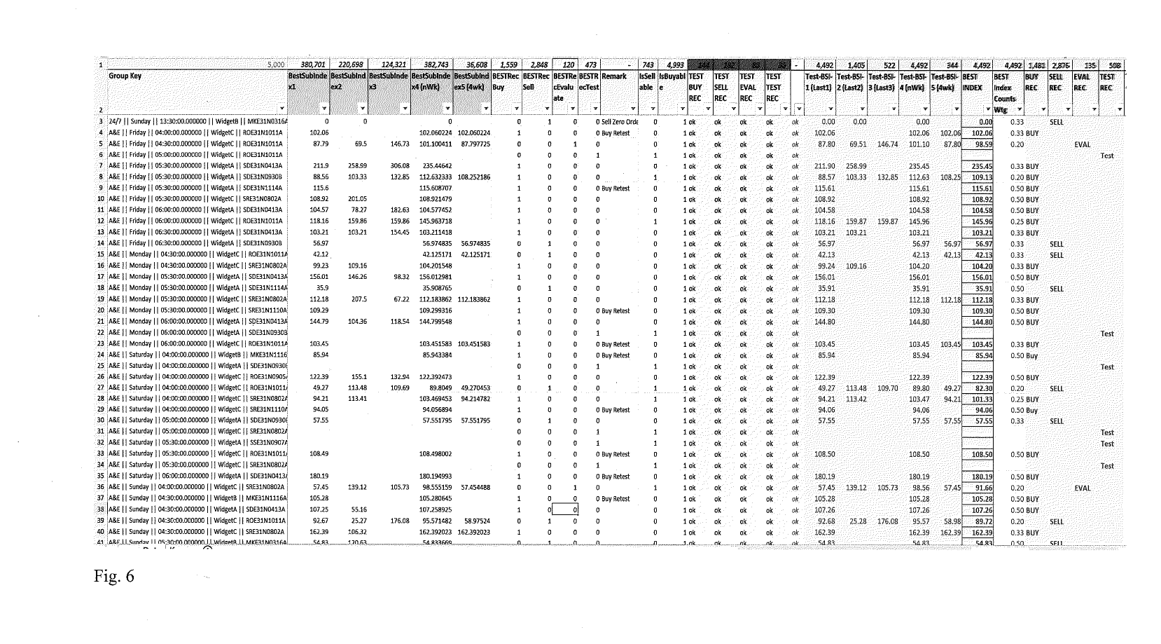

Self-Adjustment. In Step S130, the computer-implemented method can include a series of variable calculation components that automatically self-adjust based on the data available within the time period and time groupings indexes (Component Indexes). While the maximum number of defined variables for this embodiment can be increased or decreased as a primary structure by the user, the fundamental premise is to use a blend of individual Events with a blend of Event Ranges and allow them to self-adjust based on data availability within the business rules for each Component Index. By way of example, FIGS. 5A-5D and 6 show five Component Indexes. Further, FIGS. 5A-5D and 6 illustrate five component indexes that can be used and defined as follows:

Latest Airing (or Last Event)—represents either the Latest Individual or Latest Grouped Events depending on how the business rules are configured. For example and by means of comparison, Long Form/Program length Media Events with the same Group Key of Station, Creative [and/or Offer], Day, Time would mainly be individual events by Date vs. Short Form whereby their Group Key of Station, Creative [and/or Offer], Rotation Days, Rotation Times, [Media Length] would mainly be grouped events by week. In addition, Short Form program length media events can be grouped by Daypart or Day&Daypart instead of Rotation Days and Rotation Times as another variation. This can be used for each of the five (or more) Component Indexes.

Second Latest Airing (or 2nd Last Event)—represents either the Second Latest Individual or Second Latest Grouped Events depending on how the business rules are configured. For example and by means of comparison, Long Form/Program length Media Events with the same Group Key of Station, Creative [and/or Offer], Day, Time would mainly be individual events by Date vs. Short Form whereby their Group Key of Station, Creative [and/or Offer], Rotation Days, Rotation Times, [Media Length] would mainly be grouped events by week.

“n” Latest Airing (or nLast Event)—represents either the nLatest Individual or nLatest Grouped Events depending on how the business rules are configured. For example and by means of comparison, Long Form/Program length Media Events with the same Group Key of Station, Creative [and/or Offer], Day, Time would mainly be individual events by Date vs. Short Form whereby their Group Key of Station, Creative [and/or Offer], Rotation Days, Rotation Times, [Media Length] would mainly be grouped events by week.

nWeek (or nWeekRange2)—represents the aggregate calculated Index Value for the n Week Range where n=number of weeks in the range. For example, if the Index were based 100% on CPO (as described above), then the aggregate calculation value for this Index would be (CPO Target)/(Sum(NetMedia for nWeeks)/Sum(Orders for nWeeks)).

4Week (or nWeekRange2)—represents the aggregate calculated Index Value for the n Week Range2 where n=4 weeks in the range for these FIGS. 3 and 4. For example, if the Index were based 100% on CPO (as described above), then the aggregate calculation value for this Index would be (CPO Target)/(Sum(NetMedia for 4Weeks)/Sum(Orders for 4Weeks)).

Step S140 of FIG. 1 shows that the computer-implemented method may include applying the at least one predictive scores associated with the group keys to a plurality of thresholds, each threshold having default values for group keys that score within predetermined ranges and allowing for incorporating user input that overrides the default values. The predictive score can represent 100% of a weighted average of one Index metric associated with the N (number) of parameters or it can represent a weighted average between multiple indexes where the user determines the weight applied to each score.

In step S150 of FIG. 1, the computer-implemented method can include providing the at least one media transaction recommendation for the group keys based on the applied threshold values and based on the automatically adjusting. The recommended actions can include, but are not limited to, (1) buy additional media, (2) sell and/or stop using media, (3) user needs to evaluate whether media should be bought or (4) test media.

Performance Classifications (B.E.S.T.®)—This is a Scoring process based on historical activity relative to a defined set of criteria and combinations. Using the Index Metrics above, Media Events are scored within ranges set by a user or a designated administrator. For purposes of this documentation and by way of example, the following ranges can be utilized. First, in one embodiment, if the final score exceeds 100.00, a buy recommendation is provided. In one embodiment, for a non-Test group key, a score of 100 or greater will generate a Buy recommendation.

Next, if the final predictive score is between 90.00 and 100.00 as set by the Variance Threshold in the Configuration Module, an evaluate recommendation is provided. Third, if the score is between 0.00 and 90.00, a sell recommendation is provided. Fourth, if no historical media event results exist based on a predetermined or selected time period (or date range), a test recommendation is provided. This Historical period can be predetermined or user-selected, such as 180 days, 365 days, year over year, quarter over quarter, selected Start Date to selected End Date, etc. The fifth recommendation is SellZero, which is a special sub classification of Sell where Media Events designed to generate a response have not generated any or have had any assigned, attributed or sourced to them are therefore designated or flagged accordingly. For Example, SellZero Orders are Historical Media Events with no associated Orders; SellZero Leads are Historical Media Events with no associated Leads; SellZero Calls are Historical Media Events with no associated Calls. As discussed above, the various recommendation thresholds can be modified in the configuration module by the user.

Thus, a computer-implemented process can be used that recommends actions to be taken on buying and selling and retitling media to advertise and/or promote a product or service based on a unique combination of variables that form a group key that combines identifying elements of a single media event where each event has one or more target performance metrics and associated values to those metrics that it needs to achieve as well as historic values for that metric that are used in combinations to calculate an index (for each metric) comparing the actual value to the target value and, since multiple indexes are incorporated into the B.E.S.T.® process, each index is weighted by the user as to its implied contribution to a final predictive score calculated for each group key where the selection of the historical media events (that fall into the group key) that make up the parameters of the B.E.S.T.® process include, but are not limited to, a number of current or recent distinct and successive events and a number of historical groupings of events where each parameter can be weighted by the user in any combination and incorporated whereby the predictive score generated will dictate the media recommendation outputted to the user after being subjected to various considerations including but not limited to: 1) a variance threshold and 2) a test threshold where each allows the user to override default values that determine whether certain recommendations are made for group keys that score within defined ranges. An example of one embodiment can be seen in FIG. 10.

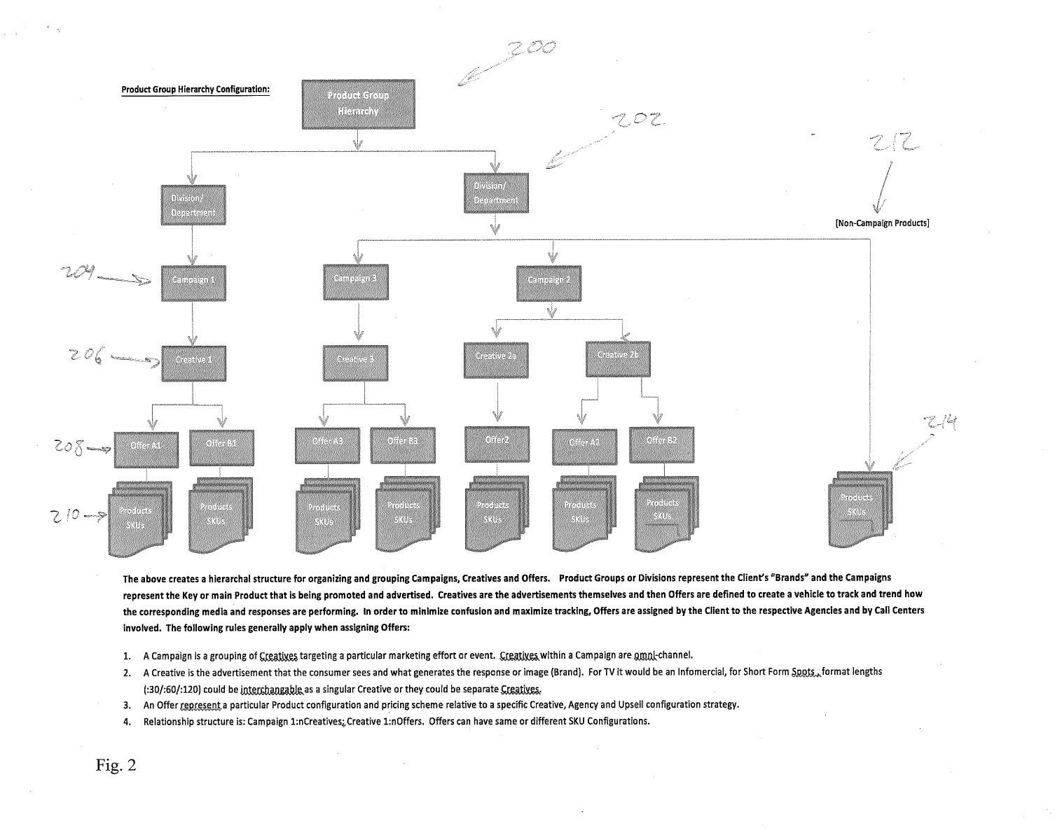

FIG. 2 illustrates one embodiment of a product group hierarchy 200. While the Figure refers to products, it can also apply to services as well. Product group hierarchy 200 enables the grouping of Departments or Divisions 202, Campaigns 204, Creatives 206 and Offers 208 with similar characteristics, pricing, and attributes. Product group hierarchy 200 is embedded in the B.E.S.T.® Process to utilize historical Results and Indexes to use as a basis to Buy media for new Campaigns 204, Creatives 206 and Offers 208. An offer can be a particular Product configuration and pricing scheme relative to a specific Creative, Agency and Upsell configuration strategy.

Normalization can be used for every type of metric that is being used to normalize the ratio. For example, in the case of a set target that is set by the marketer, the ratio can be measured against that target. If the score goes over the target, it exceeds 100. Thus, each ratio can be put on a scale of 100, which allows for comparing across metrics.

Systems in the art cannot transfer the history of one asset to another. If one offer is out there and the history is there, it cannot utilize the history on one offer to apply to another. It is a tedious task to do manually. The B.E.S.T.® process can achieve an analysis of different offers based on the history at the department level 202 and at the creative level 206 by using the history of the department 202. By using that history, we can use the history for an upcoming creative 206.

A company could have multiple divisions or departments 202, which could have multiple products or services 210. Within each of the different products or services, there can be campaigns or promotions for direct consumer response. For example, within each campaign 204 can be at least one creative 206, which are creative elements that communicate what the offer is or what they want to inform the consumer on. The offer 208 can be the actual terms and conditions of getting the product or service 210. For instance, offer A1 could result from a creative promotion on a website whereas offer B1 could result from a television advertisement. Depending on the medium, the different creative can result in different offers. For example, in the case of an offer for a car, offer A could be free financing for 60 days and offer B could be a better lease program.

Alternatively, for indirect consumer response 212, a division or department can use non-campaign products 214, for example, to increase brand awareness without necessarily linking to offers. Nielsen can rate the station where the advertisement and classifies the slot by gender, etc. For example, if a company that sells certain products or services that does not advertise those products or services can benefit indirectly from indirect consumer response marketing. In both the direct and indirect consumer response approaches, the present invention can allow for effective optimization of media acquisition. Thus, an embodiment of the invention implements the capability to leverage the history on one or more campaigns and creatives and apply it to new campaigns and creatives based on certain attributes and similarities such as (but not limited to) responses by gender, demographics, product categories, price points, etc. as well as Nielsen and other third party Impressions and/or circulation data or any combination thereof.

Thus, in FIG. 2, multiple campaigns can run for a product group within multiple divisions or departments. Thus, at each level of product group hierarchy 200, division/department 202, campaign 204, creative 206 and offer 208, media acquisition can be assessed based on media response. For example, the process can be run at the department level 202. In another embodiment, the process can be performed at the campaign level 204, or at the creative level 206. Each of these involves a different business rule that is incorporated into the process and can be seen in the Marketing Driver section 336 of FIG. 7B. For example, at a higher level, re-titling may be employed in the department or campaign, buy/sale decisions can be seen on creative. Thus, if a creative says to sell, but the time period is desired, a switch in the creative that is performing well can be switched. In this manner, a cancellation penalty can be avoided because a new creative is run in its place.

Hierarchal Relationship structure is: Campaign 1:nCreatives; Creative 1:nOffers. Offers can have same or different SKU Configurations.

In FIG. 3, a data flow illustrates how ingest process populates media data into the database. On the left side, the media agencies are getting the media data, making their own decisions about the data, and sourcing the data. On the right side, independent data coming from call centers, web, and retail centers, that are also sourced independently of the media data to incorporate time zone information, for example. Thus, based on the better granular data based on the sourcing, a better attribution of the web orders can be implemented. While the data from both the left side (i.e., media agency data) and the right side (i.e., call centers, web data and retail centers) can be combined into the B.E.S.T.® sourced data table, the data table does not have to combine both sides and can instead contain either side independently. Further, through retail allocation, retail data can be included or not included in the right side data. In addition, other combinations of the data are possible based on configurations found in FIG. 7.

Based on a uniquely scalable system configuration, up to hundreds of thousands of records can be processed in milliseconds, as will be described here. Extract, load and transform (ETL) processes can be performed on each type of incoming records. For example, on left side 250 of FIG. 3 for media agency data 252, a media agency ETL process 254 runs the calculations and loads the data into a staging table 256. By using an ETL process, it allows for adjusting data on the fly. Otherwise, when a user would want to access data on updated configurations, a long wait time of up to twenty minutes to an hour all the while using up a lot of resources of the computer. Thus, by using ETL processes 254, 264, 266, 268 for all incoming data, fewer resources and a faster system is possible while the user is hardly affected by any downtime based on the predetermined refresh operations.

As part of the import data process, each of the incoming records types are staged in respective staging tables 256, 270, 272, 274, until a refresh operation is performed. The data can then be migrated to a response table after which calculations can be performed to incorporate all possible variations and permutations of each of the metrics and group keys into the user platform. Upon the refresh operation, which can be performed at predetermined time periods or by the user, the media agency data can be incorporated into the report table after a B.E.S.T.® A Calc 258 operation performs calculations for storing reports. Then the media agency data can be in the live database used by the users. In this way, it is possible to have almost instantaneous access to any data regardless of the selected configuration settings because the data is pre-calculated before the settings have been selected.

Similar to the left side 250, the right side 260 migrates data using ETL processes 264, 266, 268. Based on the business rules that are applied, media data is incorporated into the sourced data table source table 280 so that that calculations are run for any media data. For web data, the web attribution step 276 layers additional information into the web data for importation into the sourced data table.

FIG. 4 shows a simplified representation of a core part of the process. In FIG. 4, a “Truth” table shows how the Recommendations are derived across Use Cases based on rules that use the performance of Media events over N Week time periods where N Week is a configurable range by Licensee. This was used as a basis to measure and test the logic of a typical decision making process of a media buyer. The Figure has various use cases that can be used in the process that tests the logic of the process. As shown in Case (A), if a particular media event has no history, the recommendation would be a test. In this scenario, a Test Flag can be set to true for those group records that have only future airings. This can mean that there are no past airings for that group record. As shown in Case (B), if the media has 0 orders, the recommendation would be a sale. As shown in Case (C), if a group record B.E.S.T.® A Index is non-zero and the index exceeds a threshold value for each of several airing inquiries, the recommendation is set to buy for each. In the case of Case (D), an index can exceed a predetermined threshold for certain airing inquiries (N week time period 0 and period 1), resulting in a buy recommendation, but not exceed the threshold in other time periods (N week time period 2 and period 3 and above). In the case where the threshold value is not exceeded, an evaluate recommendation is provided. Furthermore, as seen in Case (E) and Case (F), if any of the time periods include an index that is below a certain threshold, the B.E.S.T.® recommendation is SELL.

FIGS. 5A-5D show additional granularity from the Truth table in FIG. 4 and adds different thresholds and weightages. This is a representation of how the Recommendations are scored based on the performance of Media events over N Week time periods. N Week is a configurable range by Licensee. Additionally, FIG. 4 different threshold values for a buy, an evaluation, a sell. If no historical transactions have taken place for a media event, the recommendation can be test, similar to FIG. 3. If there has been only a single airing, to compensate for potential misleading information associated with a small sample size, a buy-retest recommendation is possible if above a certain threshold, which can be lower than the buy threshold. B.E.S.T.® GROUP RULES: are defined similar to the B.E.S.T.® group rules in FIG. 4.

FIGS. 5A-5D also show the different weightages for different events and time frames. For instance, a first weightage can include a percentage that corresponds to a weight for the last air index. A second weightage can include a percentage that corresponds to a weight for the last two air indexes. Further, a third weightage can include a percentage that corresponds to a weight for the last three air indexes. Also, a fourth weightage can include a percentage that corresponds to a particular week index (nWeekIndex). Further, a fifth weightage can include a percentage that corresponds to a particular 4 week index (4wkIndex). Using a combination of the weighted indexes can yield a B.E.S.T.® index.

FIG. 6 shows the Group Key and how the Subindexes self-adjust based on data available and per time period. Buy/EVAL/Sell/Test options are listed in highlighted section. An example of this self-adjustment can be seen in the fifth record below where only three sub-indexes exist for the specific media event, as opposed to the possible five, so the B.E.S.T.® index weights the three sub-indexes equally at 33.33% each, rather than weight them at 20% including the two missing sub-indexes. In FIG. 6, the group key orange columns coming out of the system and the far right yellow columns validates the data in the first five columns of 16 weeks. This allows for some of the columns in the far right to have blank values where they otherwise display values in the corresponding far left fields in part because the data on the far right only goes back 16 weeks.

FIGS. 7A and 7B show an illustration of the configuration module, which can allow for defining the criteria of the B.E.S.T.® process, adjusting the weightages, alerts, notification and recommendation criteria. This can be expanded to add addition Metrics, Sub Indexes, Drivers, etc. to shape the business rules of the B.E.S.T.® process. Any Combination of Configuration Options can be selected but Metric, Sub Index Weightages, Thresholds, View by, Time Period and Marketing Driver are required.

As seen in the metric configuration 326, various parameters from the key performance indicators described above can be configurable and assigned different weightages. Because each of the parameters is indexed, a mixing and matching of the parameters along with the weightages is possible. Without the indexing, the combination of the parameters would not be combinable. Next, the sub-index weightages section 328 can be configurable and assigned different weightages. Each of the thresholds is set to predetermined values, but are user-configurable.

Further, in FIG. 7A, the recommendation thresholds 330 are configurable. The view by metric 332 can be configured to change based on the type of media. For example, for television, if the media is cable, the frequency of view can be selected. Also contemplated within the scope of this invention is internet view by metrics.

As shown in FIG. 7B, the time period range 334 can also be configurable, for example, in four-week increments. However, other time periods are also contemplated within the scope of the invention. Further, a date range that allows for customizable date ranges is shown.

Next, the marketing driver section 336 allows the user to change the level of the product hierarchy that the index is being based off, and thus the level of the product hierarchy that is being assessed. For example, the marketing driver section 336 can be set to look at the creative level. Next, targets in the target section 338 can be stored at either the offer level or the creative level. In the Margin Model option, a live feed can factor in costs associated with granular data.

The B.E.S.T.® Index Driver portion 340 corresponds to which portion of data to include in the data flow. For example, the agency sourced option allows for the left side of the flow to be included in the database. The call center sourced allows for the call center data in the right side portion to be included in the database. And the third option allows for all three options to be included. Retail is also contemplated to be an option within the scope of the invention.

Next, the Data Refresh Option section 342 allows for the user to change the days and the times that the data is refreshed, or re-calculated into the database. The hours can be selected based on time or based on an hourly schedule. Upon refresh, the view and the index decisions are updated and a switch is performed.

Next, the Action Retention section 344 allows for a user to select how long the buy/sell decisions are stored in the screen to view. FIG. 7B also illustrates various other configurations that can be incorporated into the process. For example, proximity section 346 shows airings that are back-to-back or overlapping can be detected. Saturation section 348 can show market saturation and allow for varying levels of configuration. The Rate Sensitivity section 350 can factor in a cost rate increase for a particular airing even if the index shows a buy. For example, if a particular index is 105, but the cost rate increase jumps 100%, the likelihood of maintaining that spot, it will issue an Evaluate or a Buy. The high profile index section 352 are for certain pages that are driving high impressions, if it is not driving enough sales, but I know that the media is working that is having an effect on retail, a subsidy percentage can be applied. This can help offset an index that may not have a buy recommendation that is a useful slot.

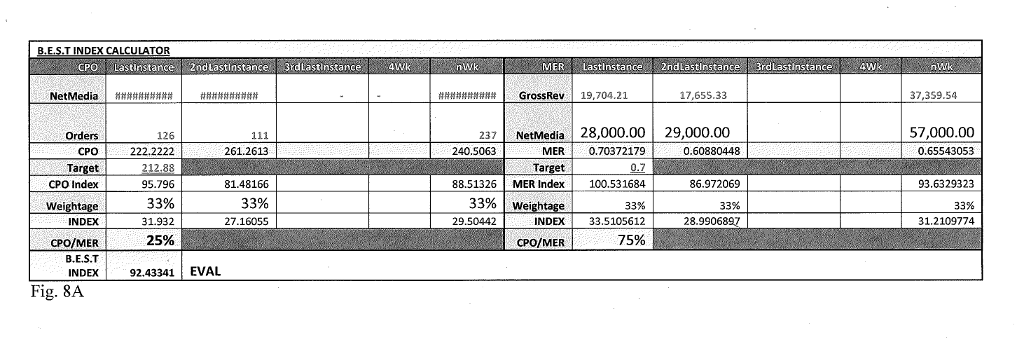

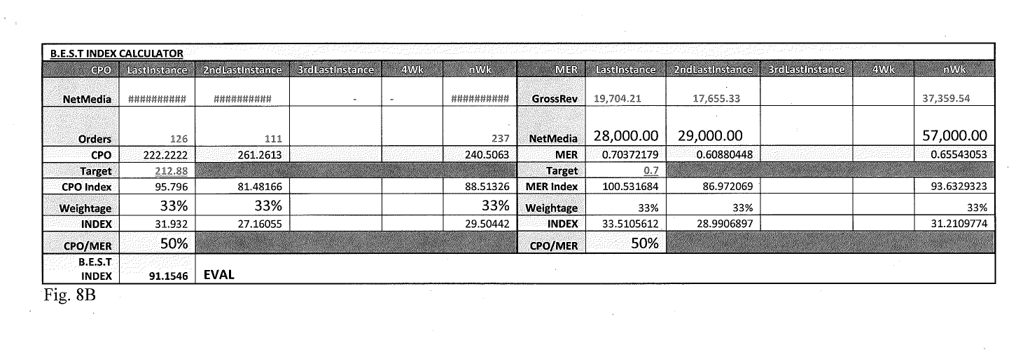

FIGS. 8A and 8B illustrate a simple way of calculating the B.E.S.T.® index. As can be seen in FIG. 8A, CPO & MER can be used but these may include many more metrics as well such as CPC, ROI, CPM, CPP, CPL, etc. Since Performance Metrics are Indexed, they can be used in any combination of one or more and be weighted based on level of impact desired by Licensee. Each Metric is Indexed vs a key Target value and then scaled to 100 where anything >=100 is performing/desired and anything <100 is underperforming. The greater the value is from 100, the stronger (or weaker if closer to zero) the result. Five Factors are used to score the overall performance, although these factors will self-adjust depending on data involved and available that match the parameters. This threshold of Five could easily be expanded well be beyond this threshold and include other factors that are not Time related such as Weather, Gas Prices, Seasonality, Life Time Value and more. For purposes of demonstration, we are only demonstrating Five Factors and focusing on Time values. The Five Factors below are split into two groups: Individual Instances (Airings, rotations, etc.) and multi-week Trend Averages that are configurable by Licensee. We typically set one to shorter term such as 4 weeks and the other are 8, 12, 16 weeks or more. Each of these Factors are weighted which again is configurable by the Licensee.

If the Licensee is conservative, they increase the weightage of the short term trend and last instance and reduce the other weightages accordingly, as shown in the difference between FIGS. 8A and 8B. If one or both of the Trend Factors have no media activity within their allotted time frames, then the model self-adjusts and these factors become null and are excluded from the B.E.S.T.® process. Similarly, if there are less than three instances, e.g. 1 or 2, then again the model self-adjusts accordingly. The uniqueness and purpose of this is to enable the model to adjust to the data set and enable it to always bring forward previous instances that otherwise would have been forgotten and overlooked by Licensee. Performance thresholds are defined to classify the Index results to create recommendations of Buy, Evaluate, Sell or Test (if no historical data exists). The standard defaults are 100+=BUY, 90 to 99.999 . . . =EVAL and below 90=SELL. A further setting is available for a single historical Instance whereby if it is greater than this TEST Threshold (BUYTEST=85+), then the system will recommend BUY even though it was less than 90 (SELL). If the Instance was at 75, then recommendation would stay as a SELL.

FIG. 9 shows an on-screen view of the platform. In the top B.E.S.T.® Index Composition example below, there were 3 previous Instances plus short term and longer term week trends. The 2LA instance show a zero which means that media ran but no Orders or Responses were generated. If no Media ran that week, then it would have listed the next available week and Index Score. In the second top B.E.S.T.® Index Composition example below, all Five Factors are available and calculated, but as mentioned above regarding what would be seen if no media occurred for a given week, no media occurred in between 3/17/14 and 4/6/14 so these weeks automatically adjusted and were ignored which is seen by the 2wk and LA Indexes matching, thereby adding extra weightage to the most current period B.E.S.T.® Index Scores. In the second top B.E.S.T.® Index Composition example below, all Five Factors are available and calculated, but as mentioned above regarding what would be seen if no media occurred for a given week, no media occurred in between 3/17/14 and 4/6/14 so these weeks automatically adjusted and were ignored which is seen by the 2wk and LA Indexes matching, thereby adding extra weightage to the most current period B.E.S.T.® Index Scores. In the third top B.E.S.T.® Index Composition example below, only a Single Instance has occurred over the past 395 days and it happened beyond the 2wk and 16wk Index Trends. All other Indexes are blanks (represented by “- -” and are excluded from the B.E.S.T.® process. Note that the Date of this Last Instance was around 6 months earlier than the current time period but the B.E.S.T.® Process brought that Instance forward and evaluated with the current media so that it was not ignored or omitted from the B.E.S.T.® process. The bottom example shows that only two Instances occurred and that they happened within the 16 Week Trend period. The 3LA and 2 week Trend were blank and ignored by the B.E.S.T.® process via its self-adjustment logic.

FIG. 10 shows a different view of the platform of a long form, as shown in FIG. 9, with the Group Key comprising of the first 5 columns (excluding Row). B.E.S.T.® Index Scores and corresponding Recommendations are listed on each Group Key Row and Licensee can choose to BUY or SELL Future Media accordingly.

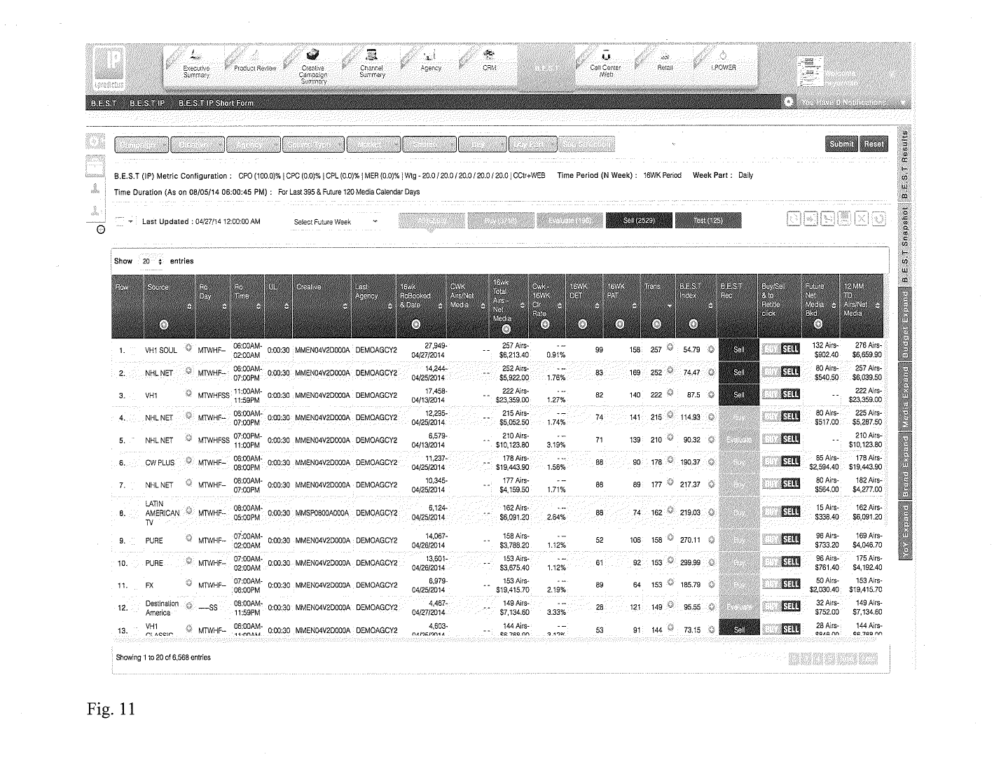

FIG. 11 shows a different view of the platform in FIG. 10 of the Long Form with the Group Key comprising the first 6 columns (excluding Row). NOTE: LF had a Group Key of 5 components whereas SF has been configured with 6 and more could be added or reduced as requested by Licensee, depending on the level of separation and detail that they are seeking to attain. As can be seen from the Figure, B.E.S.T.® Index Scores and corresponding Recommendations are listed on each Group Key Row and Licensee can choose to BUY or SELL Future Media accordingly. Note that LF Transactions were based on individual Airing slots or Time periods whereas SF (in example below) is using Rotations as represented by RoDays, RoDays and RoBooked.

After making some optional decisions to override default values that drive the recommended actions, the user can be presented with a line-by-line view of specific media buys, airing and/or rotations with a recommendation to buy, sell or evaluate the buy, airing and/or rotation. If no historical data exists, then these buys, airings, and/or rotations are flagged as test. The user may have the power to override any Buy/Sell decision by using input device 1610, as shown in FIG. 11 or they may want to Retitle (Buy) under at a different Campaign or Creative.

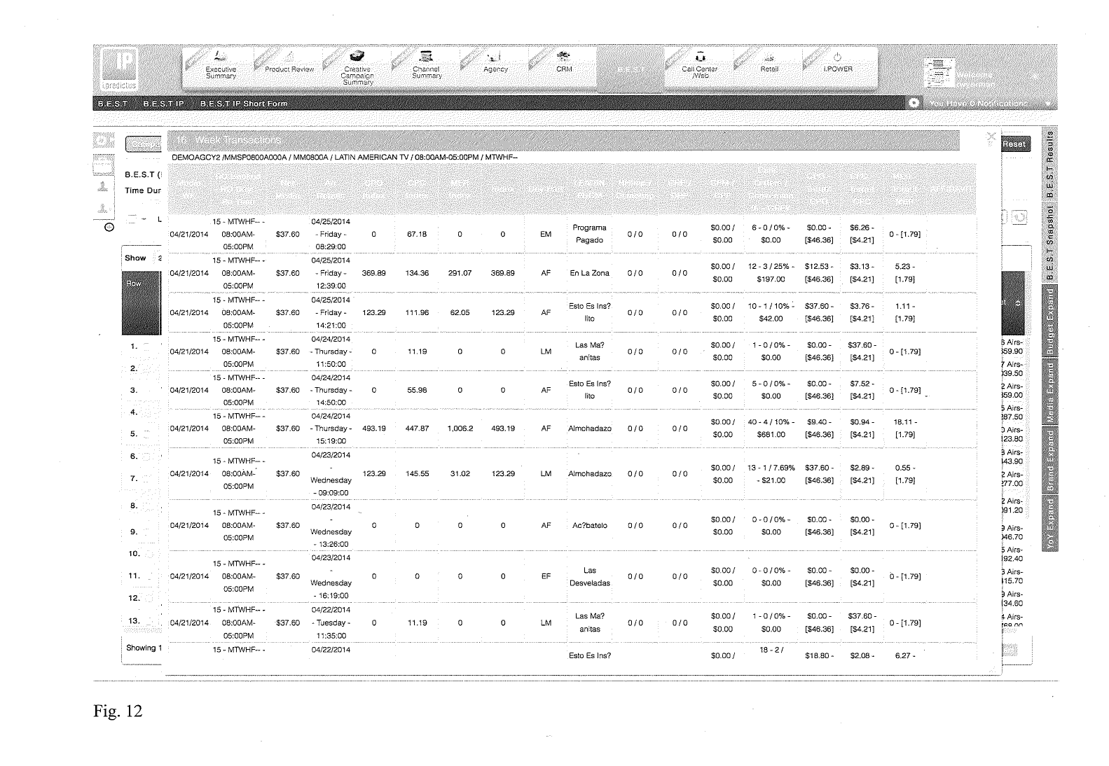

FIG. 12 shows a different view of the platform. As seen below, even though SF can be bought in rotations, each individual Airing (column “Air Details”) or Instance is Scored through a variety of Metrics and Index. Thus, as can be seen, one embodiment of the present invention includes a rules based scoring process or engine that has a Licensee definable framework for enabling the establishment and execution of configurable business rules, variables, weightages, data types and key metrics to score Media based on historical performance, both directly and indirectly through “Product and Services Hierarchies”, Source/Station Profiles and across one or more consumer response data sets, including but not limited to Calls, Orders, Visits, Likes, Tweets, Impressions, Circulations, lists, Retail, etc., for the purposes of scoring past media and applying quantifiable decisions for recommending and transacting current and future media purchases/acquisitions.

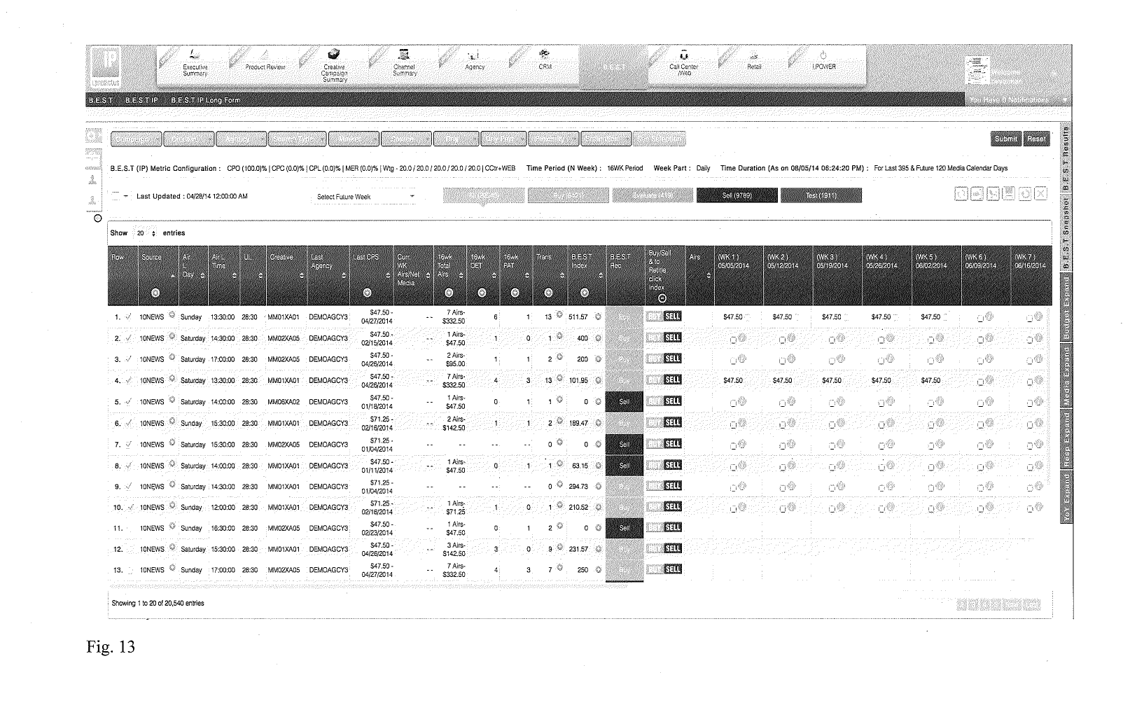

FIG. 13 shows a view of the platform using IP Long Form. As seen in the Figure, Future Media Instances can be Bought (BUY), Sold (SELL/Canceled), or Retitled whereby the Media Instance is switched from one Creative versus another. This can be especially vital when Testing new Campaigns and Creatives or making Media Adjustments to stay within Budgets. Media can be bought, sold/canceled, and retitled per week. The Buy/Sell button and the Weeks can be clicked on and expanded to the right for a user to action these Group Key Records. Once all selections are made User can save the Actions and then Push them to the Agency or to themselves via the system. Each of the “I” buttons open up a window for selection/entering comments that are then included with Buy/Sell/Retitle actions sent to the Agency.

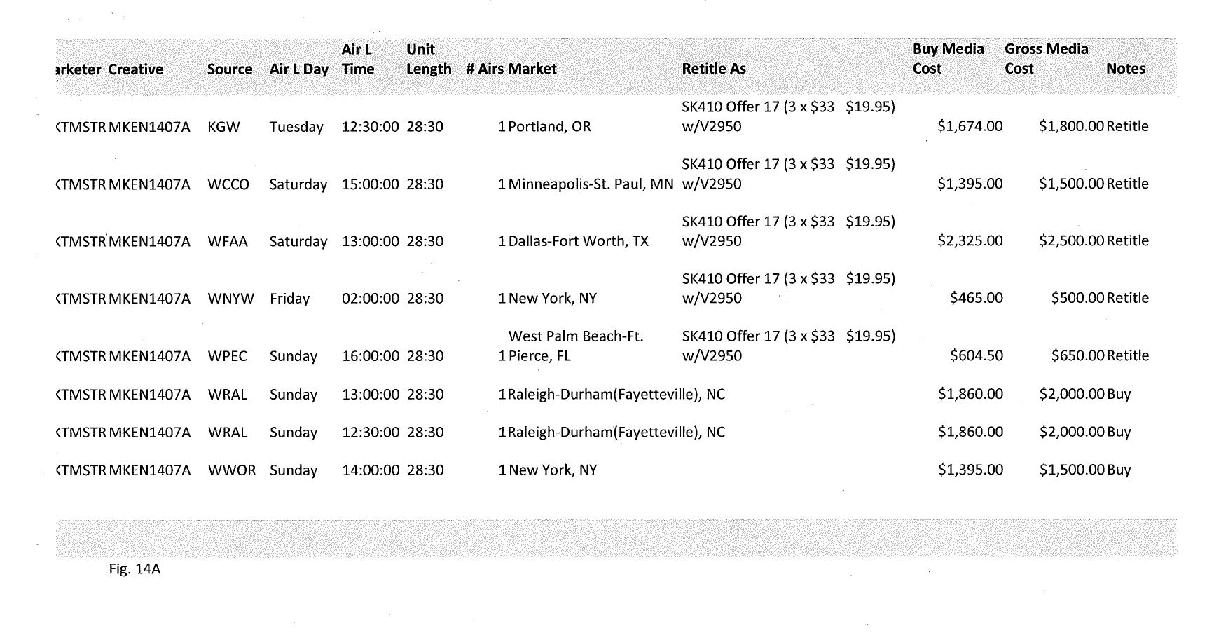

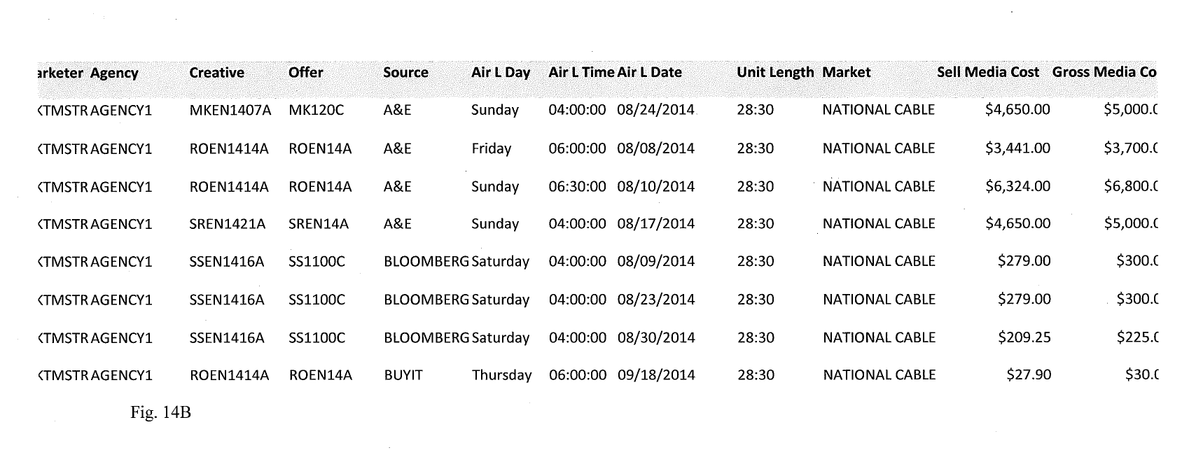

FIG. 14 shows examples of buy/sell actions to agencies. As can be seen, examples of Buy, Sell and Retitle Actions that can be sent to media agencies for processing. Based on changes that are constantly being implemented into the database, future rates can be evaluated using a moving window so that a particular time slot in the future may turn into a buy that previously was unavailable. Thus, buy/sell recommendations can be assessed in real-time or in the future.

Thus, the B.E.S.T.® Index can already drive the Recommendations and the User can make the decision which Group Records to Action on and for what period of time in the future. A user can be an individual who has access and permissions to use the system. These actions are not overriding default values, they are communicating which actions to take: Buy, Sell, the quantity, the weeks and if Retitle, they also select the Creative or Offer. If the Group Record is TEST and it has Future Media, User can Sell or Retitle this or they can add more in weeks where Future Media does not exist. See FIGS. 13 and 14.

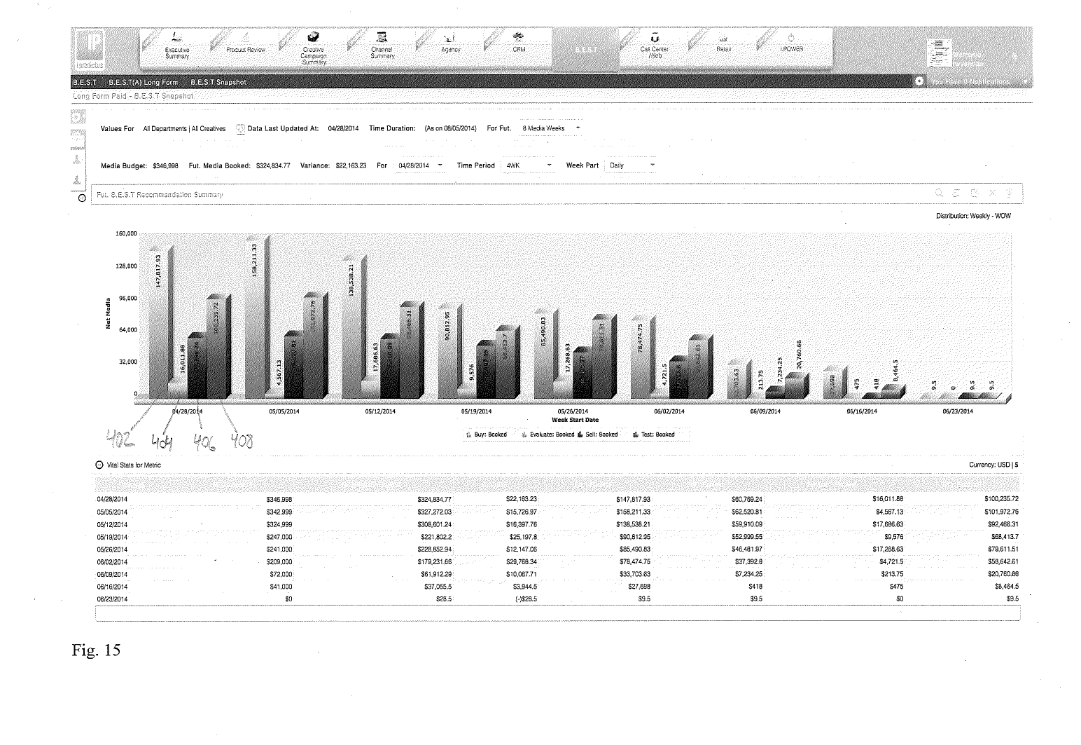

FIG. 15 shows a B.E.S.T.® snapshot summary view in another illustration of the platform. Below shows the result of scoring Future Booked Media via B.E.S.T.® Index process and segmenting it by Performance Category. This is based on how the B.E.S.T.® process scored the historical results of the Group Key and applied this score to Future Media. This View can be important to Marketers and Agencies to see how their Future Media is predicted to perform. SELL (406) is of particular interest so that they can quickly react and Sell/Cancel this Media or Retitle it to another Creative. TEST Media (408) is Media that has no historical results and is considered to be more Risky than BUY 402 but less risky then SELL 406. Further, Evaluate can be found in 404 of the same graph.

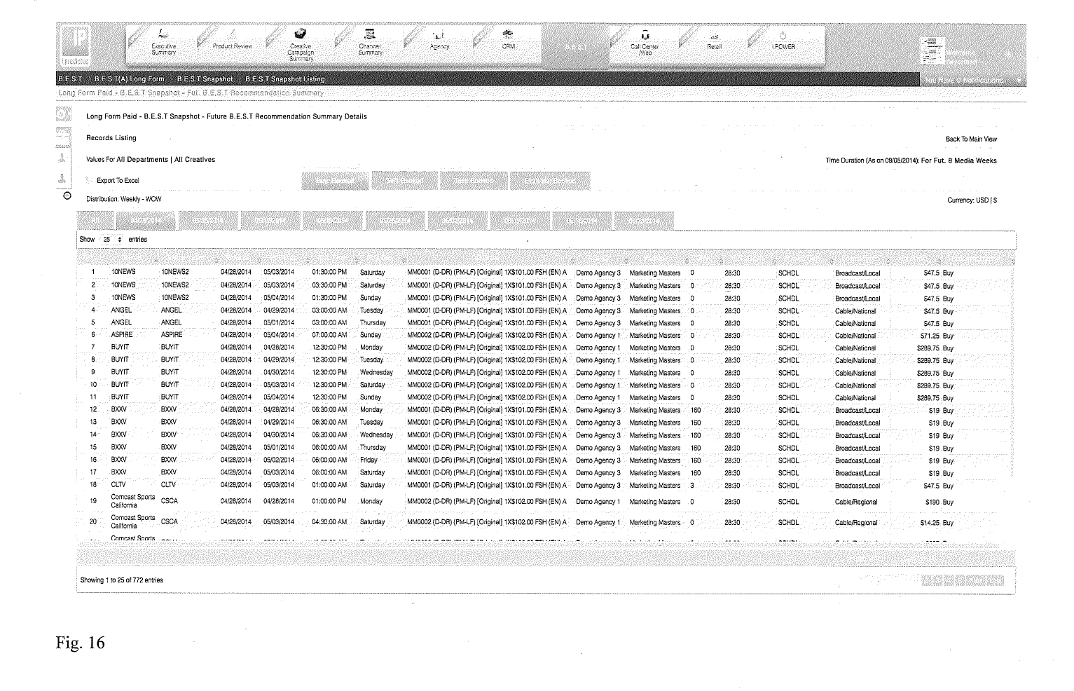

FIG. 16 shows a detailed view of B.E.S.T.® process future buys. As can be seen from the Figure, Future Booked Media is Scored via B.E.S.T.® Index process and Performance Category.

In one embodiment, the invention can enable an Evergreen Effect. For example, if the Last Event, second to last Event and/or nLast Event(s) fall outside of the nWeek Ranges 1 and 2, then nWeek Ranges 1 and 2 are Null and only the Last/Latest Events that are available are used. This characteristic is unique and keeps older Events outside of the nWeek Ranges in Current view and consideration, creating an “Evergreen effect” that is not done by any other system or calculation process.

In another embodiment, the invention can enable an exposure Protection, which is the blending of Component Indexes between Individual Events and Range Events has a built in protective characteristic that minimizes risks on Event acquisition by recalculation of Scores with each added Event and readjustment of the media action Recommendations. For example, for Performing Group Key Events, as they begin to underperform, the blend of a limited number of Individual events with Range Events limits risk impact of underperforming Events.

In another embodiment, the invention can enable Index Subsidies, which are Subsidies that can be added to so that scores can be adjusted by other external factors such as event rate sensitivity and retail index subsidies. For example, Event Rate Sensitivity can include Adjusting the Group Key final B.E.S.T.® Index recommendation by variations in Future Rates (increases or decreases). Further, Retail Index Subsidies can include Adjusting the Group Key final B.E.S.T.® Index recommendation by Retail Sales Subsidies where Group Key Events are seen/known to increase Retail Sales. In these cases, the Subsidies increase the underperforming results by a factor so that the Sell Recommendation may change to Evaluate or Buy instead if the Subsidy is large enough in conjunction with the B.E.S.T.® Index Group Key Score.

One embodiment of the invention can be used with any Marketing Channel and because of the Index structure it enables “apples-to-apples” comparison across all channels and all price points. It is a singular performance metric process and system based on (a) Business Rules and Definitions; (b) Configurable Components and Variables; (c) Scalability; (d) Adaptability; (e) Self Adjusting; and (f) Balanced/Equitable.

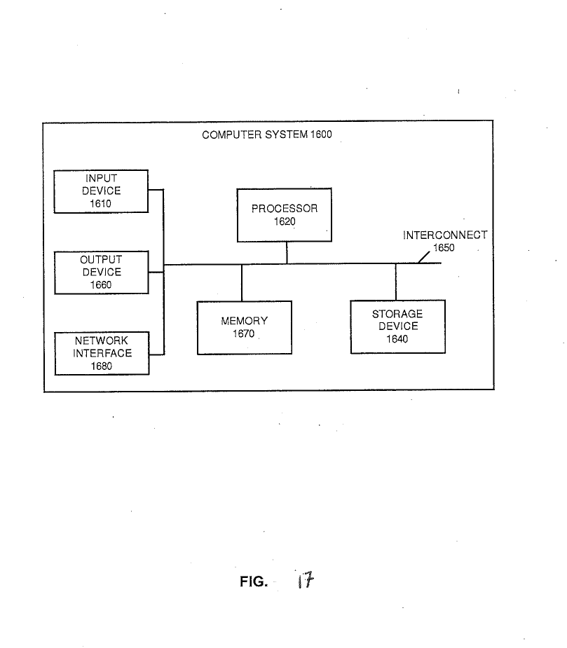

FIG. 17 illustrates a working example of an embodiment of the current invention. A user interface 200 can allow for a user to input data to be used in the computer-implemented method. ILLUSTRATIVE COMPUTING ARCHITECTURE EXAMPLE SYSTEM

FIG. 17 illustrates an example of a computer system 1600 that may be configured to practice an embodiment of the invention. For example, computer system 1600 may be used to implement client 1510, service provider 1550, target environment 1560, programming environment 100, etc. Computer system 1600 may include processor 1620, memory 1670, storage device 1640, input device 1610, output device 1660, and network interface 1680. Processor 1620 may include logic configured to execute computer-executable instructions that implement embodiments of the invention. An example of a processor that may be used with the invention includes the Pentium® processor, Core i7® processor, or Xeon® processor all available from Intel Corporation, Santa Clara, Calif. The instructions may reside in memory 1670 and may include instructions associated with TCE 1520.

Memory 1670 may be a computer-readable medium that may be configured to store instructions configured to implement embodiments of the invention. Memory 1670 may be a primary storage accessible to processor 1620 and can include a random-access memory (RAM) that may include RAM devices, such as, for example, Dynamic RAM (DRAM) devices, flash memory devices, Static RANI (SRAM) devices, etc. Storage device 1640 may include a magnetic disk and/or optical disk and its corresponding drive for storing information and/or instructions. Memory 1670 and/or storage device 1640 may store class definitions 1405-1475.

Interconnect 1650 may include logic that operatively couples components of computer system 1600 together. For example, interconnect 1650 may allow components to communicate with each other, may provide power to components of computer system 1600, etc. In an embodiment of computer system 1600, interconnect 1650 may be implemented as a bus.

Input device 1610 may include logic configured to receive information for computer system 1600 from, e.g., a user. Embodiments of input device 1610 may include keyboards, touch sensitive displays, biometric sensing devices, computer mice, trackballs, pen-based point devices, etc. Output device 1660 may include logic configured to output information from computer system. Embodiments of output device 1660 may include cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc.

Network interface 1680 may include logic configured to interface computer system 1600 with a network, e.g., network 1540, and may enable computer system 1600 to exchange information with other entities connected to the network, such as, for example, service provider 1550, target environment 1560 and cluster 1570. Network interface 1680 may be implemented as a built-in network adapter, network interface card (NIC), Personal Computer Memory Card International Association (PCMCIA) network card, card bus network adapter, wireless network adapter, Universal Serial Bus (USB) network adapter, modem or any other device suitable for interfacing computer system 1600 to any type of network.

It should be noted that embodiments may be implemented using some combination of hardware and/or software. It should be further noted that a computer-readable medium that includes computer-executable instructions for execution in a processor may be configured to store embodiments of the invention. The computer-readable medium may include volatile memories, non-volatile memories, flash memories, removable discs, non-removable discs and so on. In addition, it should be noted that various electromagnetic signals such as wireless signals, electrical signals carried over a wire, optical signals carried over optical fiber and the like may be encoded to carry computer-executable instructions and/or computer data on e.g., a communication network for an embodiment of the invention.

A hardware unit of execution may include a device (e.g., a hardware resource) that performs and/or participates in parallel programming activities. For example, a hardware unit of execution may perform and/or participate in parallel programming activities in response to a request and/or a task it has received (e.g., received directly or via a proxy). A hardware unit of execution may perform and/or participate in substantially any type of parallel programming (e.g., task, data, stream processing, etc.) using one or more devices. For example, in one implementation, a hardware unit of execution may include a single processing device that includes multiple cores, and in another implementation, the hardware unit of execution may include a number of processors 1620. A hardware unit of execution may also be a programmable device, such as a field programmable gate array (FPGA), an application specific integrated circuit (ASIC), a digital signal processor (DSP), etc. Devices used in a hardware unit of execution may be arranged in substantially any configuration (or topology), such as a grid, ring, star, etc. A hardware unit of execution may support one or more threads (or processes) when performing processing operations.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

We claim:

1. A computer-implemented method for generating at least one media transaction recommendation for use in advertising a product or service, the method comprising:
updating, at an approximately continuous rate, attributes data of a plurality of media events into a staging table in a database on a data storage device;
at predetermined time intervals, indexing, using at least one processor, a plurality of key performance indicators for a plurality of group keys using the attributes data, each group key comprising at least four variables associated with a media event, the indexing of each key performance indicator being performed based on a ratio between actual value data that fits within the group key variables and target metric data for the key performance indicator, the indexing including all possible combinations of actual value data parameters representing at least one of a number of distinct and successive media events and a number of time periods of the media events, the indexing including all possible combinations of normalized (i) weightages assigned to each indexed key performance indicator, (ii) weightages assigned to combinations of indexed key performance indicators, (iii) weightages assigned to time periods of the actual value data, and (iv) weightages assigned to media events associated with the group keys, the weightages and time periods including default predetermined values;
generating at least one predictive score associated with each group key based on the indexed data from a report table in the database that includes the indexed data and based on a plurality of predetermined rules, each predictive score being configurable through a configuration module where settings such as the weightages and time periods are configurable by user input;
automatically adjusting the applied predictive score in real-time from the previously indexed all combinations, using at least one processor, based on the updated user input in the configuration module;
applying the at least one predictive scores associated with the group keys to a plurality of thresholds, each threshold having default values for group keys that score within predetermined ranges and allowing for incorporating user input that overrides the default values; and
providing the at least one media transaction recommendation for the group keys based on the applied threshold values and based on the automatically adjusting.

2. The method of claim 1, wherein the group key is a unique identifier of a media event that combines elements of a level of a group hierarchy, a media event source, the time of the media events.

3. The method of claim 2, wherein:
the time excludes data of month, day, and year of the media event to allow for performance trending of the group key, and
the performance trending is adapted to allow for the evaluation and analysis of performance metrics for a group key over any period of time based on how recent the performance trending is to the current date and length of time.

4. The method of claim 3, wherein the parameters are time-based media events within a group key where different values of the number of the most recent events are analyzed along with aggregate level trending variables.

5. The method of claim 1, wherein the attributes data is processed into the staging table through an extract, transform, and load process.

6. The method of claim 5, wherein the attributes data includes a plurality of sources of data, each of the sources being stored in a respective staging table in the database.

7. The method of claim 6, wherein the plurality of sources of data is configured to be sourced together based on the settings in the configuration module.

8. The method of claim 1, wherein the single media event is directed to at least one of: television time for brand awareness, direct response television time to sell a product or service or to generate a lead, radio time for brand awareness, direct response radio time to sell a product or service or to generate a lead, web advertising, SMS messaging, and print advertising.

9. The method of claim 1, wherein the media recommendations include at least one of: buy additional media; sell media; stop using media; evaluating whether media should be bought; and
test media.

10. The method of claim 1, wherein the predetermined time intervals are configurable by the user in the configuration module.

11. The method of claim 1, wherein:
the target metric data are user-defined goals for a specific advertising campaign featuring a specific offer, the specific advertising campaign referring to at least one of direct and indirect consumer response that includes at least one of: media cost per order (CPO), media efficiency ratio (MER), phone conversion rate, clearance rate, cost per airing (spot), cost per call (contact, CPC), cost per thousand impressions (CPM), and return on investment percent (ROI),
in the case of CPO, the index of the key performance indicator equals the CPO target for the specific product and offer divided by actual CPO times 100, and
the offer is a package of products or services and incentives grouped in an advertisement to generate a response.

12. The method of claim 1, wherein parameters comprise a predetermined number going back a pre-defined period of time that match a group key and a pre-defined number of distinct grouped time periods in which airings that match the group key run.

13. A computer system for generating at least one media transaction recommendation for use in advertising a product or service, the computer system comprising:
a memory storing computer-executable instructions; and
at least one data processor that when executed cause the computer system to perform steps of:
updating, at an approximately continuous rate, attributes data of a plurality of media events into a staging table in a database on a data storage device;
at predetermined time intervals, indexing a plurality of key performance indicators for a plurality of group keys using the attributes data, each group key comprising at least four variables associated with a media event, the indexing of each key performance indicator being performed based on a ratio between actual value data that fits within the group key variables and target metric data for the key performance indicator, the indexing including all possible combinations of actual value data parameters representing at least one of a number of distinct and successive media events and a number of time periods of the media events, the indexing including all possible combinations of normalized (i) weightages assigned to each indexed key performance indicator, (ii) weightages assigned to combinations of indexed key performance indicators, (iii) weightages assigned to time periods of the actual value data, and (iv) weightages assigned to media events associated with the group keys, the weightages and time periods including default predetermined values;
generating at least one predictive score associated with each group key based on the indexed data from a report table in the database that includes the indexed data and based on a plurality of predetermined rules, each predictive score being configurable through a configuration module where settings such as the weightages and time periods are configurable by user input;
automatically adjusting the applied predictive score in real-time from the previously indexed all combinations based on the updated user input in the configuration module;
applying the at least one predictive scores associated with the group keys to a plurality of thresholds, each threshold having default values for group keys that score within predetermined ranges and allowing for incorporating user input that overrides the default values; and
providing the at least one media transaction recommendation for the group keys based on the applied threshold values and based on the automatically adjusting.

14. A non-transitory computer readable storage medium configured to store computer-executable instructions for generating at least one media transaction, the computer-executable instructions when executed by at least one processor causing a computer to perform:
updating, at an approximately continuous rate, attributes data of a plurality of media events into a staging table in a database on a data storage device;
at predetermined time intervals, indexing a plurality of key performance indicators for a plurality of group keys using the attributes data, each group key comprising at least four variables associated with a media event, the indexing of each key performance indicator being performed based on a ratio between actual value data that fits within the group key variables and target metric data for the key performance indicator, the indexing including all possible combinations of actual value data parameters representing at least one of a number of distinct and successive media events and a number of time periods of the media events, the indexing including all possible combinations of normalized (i) weightages assigned to each indexed key performance indicator, (ii) weightages assigned to combinations of indexed key performance indicators, (iii) weightages assigned to time periods of the actual value data, and (iv) weightages assigned to media events associated with the group keys, the weightages and time periods including default predetermined values;
generating at least one predictive score associated with each group key based on the indexed data from a report table in the database that includes the indexed data and based on a plurality of predetermined rules, each predictive score being configurable through a configuration module where settings such as the weightages and time periods are configurable by user input;
automatically adjusting the applied predictive score in real-time from the previously indexed all combinations based on the updated user input in the configuration module;
applying the at least one predictive scores associated with the group keys to a plurality of thresholds, each threshold having default values for group keys that score within predetermined ranges and allowing for incorporating user input that overrides the default values; and
providing the at least one media transaction recommendation for the group keys based on the applied threshold values and based on the automatically adjusting.
